(19) United States
(12) Patent Application Publication
(10) Pub. No.: US 2008/0216002 A1
(43) Pub. Date: Sep. 4, 2008

(54) Image Display Controller and Image Display Method

(75) Inventor: Kouzou Morita, Saitama (JP)

Correspondence Address: FOLEY AND LARDNER LLP;SUITE 500, 3000 K STREET NW, WASHINGTON, DC, 20007, US

(73) Assignee: PIONEER CORPORATION, Tokyo (JP)

(21) Appl. No.: 11/574,439

(22) PCT Filed: Aug. 12, 2005
(86) PCT No.: PCT/JP05/14853

§ 371 Date: May 1, 2007

(30) Foreign Application Priority Data
Aug. 30, 2004 (JP) 2004-250827

(51) Int. Cl. G06F 3/048

(52) U.S. Cl. 715/764

(57) ABSTRACT

A calculating unit calculates a preference level of a user for each of a plurality of images based on data on time in a viewing history of the image, and a control unit performs a display control to display an image with a high preference level from among preference levels calculated by the calculating unit, and performs a play-back control to play music along with display of the image based on data on a date of any one of shooting and storing the image, and data on a period and number of times of listening the music. The music having a large number of times of listening within a certain period that includes the date of any one of shooting and storing the image.

### TECHNICAL FIELD

The present invention relates to an image display control apparatus and an image display method. The present invention particularly relates to an image display control apparatus that performs a control to display an image reflecting preference of a user from among a plurality of images, and an image display method for displaying an image reflecting preference of a user from among a plurality of images.

### BACKGROUND ART

With the popularization of digital cameras and cellular phones with a camera, opportunities to view at homes digital images via an image display device, such as a personal computer, have increased. Images shot by a digital camera are stored in a storage device, such as a personal computer. However, when the number of images increases, it becomes difficult to search for an image that a user desires to view from the storage device.

Japanese Patent Application Laid-open No. 2003-141504 (Patent Document 1) discloses a technology that makes it possible to easily search for an image in which a user have some interests from an image storing device in which image data is stored. The patent document describes that if one of thumbnails displayed on a display unit is selected, and an operation of viewing, printing, or transmitting the selected image is performed, relating information is automatically stored, and details of the operation are stored in associated manner with the selected image, and the stored information is used as a search key for future search.

Japanese Patent Application Laid-open No. 2001-79262 (Patent Document 2) discloses a technology in which drawing data for an image at booting-up is created and displayed every time of booting-up based on a stored history information, and the history information includes a system starting time, an idling time period for which game is not executed, the number or times of booting up an application program, and a booting-up time of an application.

Patent Document 1: Japanese Patent Application Laid-open No. 2003-141504

Patent Document 2: Japanese Patent Application Laid-open No. 2001-79262

### DISCLOSURE OF INVENTION

### Problem to be Solved by the Invention

According to the technology disclosed in Patent Document 1, an image about which image information is to be stored (image in which the user has an interest) is identified only based on determination whether the user selects the image, i.e., “0 or 1”. Accordingly, if the user selects the image by fault despite that the user is not interested in the image, even if another image is re-selected immediately, the image is wrongly recognized as an image in which the user has an interest.

Moreover, the degree of preference of the user may vary from image to image; however, difference in the degree of preference is not taken into account in the technology disclosed in Patent Document 1, so that it cannot be devised to display images in descending order of degree of preference when displaying images.

The above problem is an example of problems to be solved by the present invention.

One of the objects of the present invention is to provide an image display control apparatus that can perform a control to display an image reflecting preference of a user from among a plurality of images.

Another object of the present invention is to provide an image display control apparatus that can perform a control to easily search for and display an image reflecting preference of a user from among a plurality of images.

Still another object of the present invention is to provide an image display method for displaying an image reflecting preference of a user from among a plurality of images.

### Means for Solving Problem

According to the invention of claim 1, an image display control apparatus performs a control to display an image with a high preference level of a user from among a plurality of images, wherein a preference level for the image is obtained based on data on time in a viewing history of the image, and a control is performed to display the image with the high preference level based on the preference level for the image.

According to the invention of claim 12, an image display control apparatus performs a control to display an image with a high preference level of a user from among a plurality of images, wherein when a date of any one of shooting and storing is specified from among displayed candidates of a plurality of dates of any one of shooting and storing, a control is performed to display an image dated on specified date of any one of shooting and storing in a selectable manner, and a preference level for the image is obtained based on data on time in a viewing history of the image, and it is determined whether the specified date of any one of shooting and storing is to be contained in the candidates based on an average of preference levels for the images dated on a same shooting-storing date.

According to the invention of claim 13, an image display control apparatus performs a control to display an image with a high preference level of a user from among a plurality of images, wherein when a date of any one of shooting and storing is specified from among displayed candidates of a plurality of dates of any one of shooting and storing, a control is performed to display an image dated on specified date of any one of shooting and storing in a selectable manner, and it is determined whether the specified date of any one of shooting and storing is to be contained in the candidates based on a share of number of images dated on a same date of any one of shooting and storing held by number of images each of which has a viewing track record based on data indicating viewing track records for the images.

According to the invention of claim 14, an image display method for displaying an image with a high preference level of a user from among a plurality of images includes a step of obtaining a preference level of a user for each of the images based on data on time in a viewing history of the images; and a step of displaying an image with high preference level preferentially based on the preference level for the images obtained at the obtaining.

### BRIEF DESCRIPTION OF DRAWINGS

FIG. 1 is a general block diagram of an image display device to which an image display control apparatus according to a first embodiment of the present invention is applied.

FIG. 2 is a schematic for explaining an example of contents displayed on a display-output unit of the image display device to which the image display control apparatus according to the first embodiment of the present invention is applied.

FIG. 3 is a schematic for explaining another example of contents displayed on the display-output unit of the image display device to which the image display control apparatus according to the first embodiment of the present invention is applied.

FIG. 4 is a schematic for explaining still another example of contents displayed on the display-output unit of the image display device to which the image display control apparatus according to the first embodiment of the present invention is applied.

FIG. 5 is a schematic for explaining still another example of contents displayed on the display-output unit of the image display device to which the image display control apparatus according to the first embodiment of the present invention is applied.

FIG. 6 is a schematic for explaining still another example of contents displayed on the display-output unit of the image display device to which the image display control apparatus according to the first embodiment of the present invention is applied.

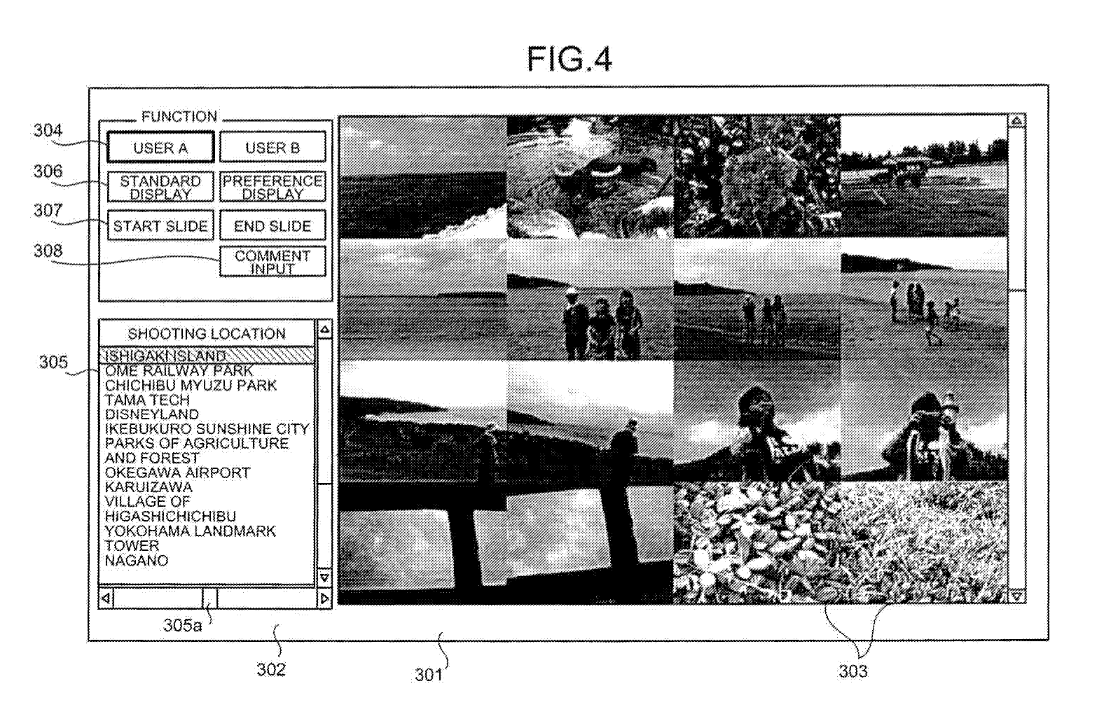

FIG. 4 is a schematic for explaining still another example of contents displayed on the display-output unit of the image display device to which the image display control apparatus according to the first embodiment of the present invention is applied.

FIG. 8 is a flowchart of an algorithm for operation of the image display device to which the image display control apparatus according to the first embodiment of the present invention is applied.

FIG. 9 is a flowchart of an algorithm for selecting a display mode of the image display device to which the image display control apparatus according to the first embodiment of the present invention is applied.

FIG. 10 is a flowchart of an algorithm for renewing a preference level in the image display device to which the image display control apparatus according to the first embodiment of the present invention is applied.

FIG. 11 is a graph of change in a preference level in the image display device to which the image display control apparatus according to the first embodiment of the present invention is applied.

FIG. 12 is a schematic for explaining an image information database in the image display device to which the image display control apparatus according to the first embodiment of the present invention is applied.

FIG. 13 is a schematic for explaining the image information database and a preference level database in the image display device to which the image display control apparatus according to the first embodiment of the present invention is applied.

FIG. 14 is a flowchart of an algorithm for operation of an image display device to which an image display control apparatus according to a second embodiment of the present invention is applied.

FIG. 15 is a flowchart of a part of an algorithm for renewing a preference level in the image display device to which the image display control apparatus according to the second embodiment of the present invention is applied.

FIG. 16 is a flowchart of another part of the algorithm for renewing a preference level in the image display device to which the image display control apparatus according to the second embodiment of the present invention is applied.

FIG. 17 is a graph of change in a preference level in the image display device to which the image display control apparatus according to the second embodiment of the present invention is applied.

FIG. 18 is a schematic for explaining an image information database and a preference level database in the image display device to which the image display control apparatus according to the second embodiment of the present invention is applied.

FIG. 19 is a schematic for explaining an example displayed on a display-output unit of an image display device to which an image display control apparatus according to a third embodiment of the present invention is applied.

FIG. 20 is a flowchart of an algorithm for operation of the image display device to which the image display control apparatus according to the third embodiment of the present invention is applied.

FIG. 21 is a flowchart of an algorithm for selecting a display mode (standard or preference) for shooting-saving dates on the image display device to which the image display control apparatus according to the third embodiment of the present invention is applied.

FIG. 22 is a flowchart of an example of an algorithm for extracting preferred shooting-saving dates in the image display device to which the image display control apparatus according to the third embodiment of the present invention is applied.

FIG. 23 is a flowchart of another example of an algorithm for extracting preferred shooting-saving dates in the image display device to which the image display control apparatus according to the third embodiment of the present invention is applied.

FIG. 24 is a schematic for explaining the example of the algorithm for extracting preferred shooting-saving dates in the image display device to which the image display control apparatus according to the third embodiment of the present invention is applied.

FIG. 25 is a general block diagram of an image display device to which an image display control apparatus according to a fourth embodiment of the present invention is applied.

FIG. 26 is a flowchart of an algorithm for operation of the image display device to which the image display control apparatus according to the fourth embodiment of the present invention is applied.

FIG. 27 is a schematic for explaining a music information and viewing history database in the image display device to which the image display control apparatus according to the fourth embodiment of the present invention is applied.

FIG. 28 is a general block diagram of an image display device to which an image display control apparatus according to a fifth embodiment of the present invention is applied.

### EXPLANATIONS OF LETTERS OR NUMERALS

10 Image input unit
20 Image storing unit
30 Image information database
40 Preference-level calculating unit
50 Preference level database
60 Display-and-operation control unit
70 Display-output unit
80 User operation unit
100 Image display device
200 Image display control apparatus

### BEST MODE(S) FOR CARRYING OUT THE INVENTION

An embodiment of an image display control apparatus according to the present invention is explained below in detail with reference to drawings.

### First Embodiment

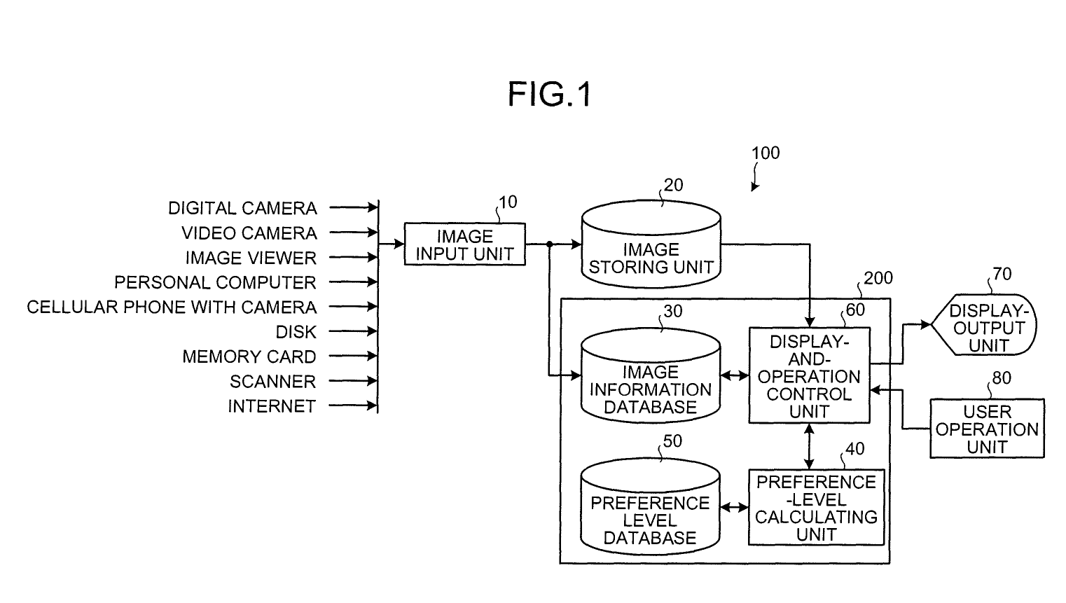

A first embodiment of the image display control apparatus according to the present invention is explained below with reference to FIGS. 1 to 13. The image display control apparatus according to the first embodiment aims to extract an image preferred by a user from among a number of images by using a preference level (degree of preference) that indicates the degree of preference of the user for the image, and to control a display-output unit (display device) to display the extracted image.

The image display control apparatus according to the first embodiment is configured as a part of an image display device. FIG. 1 is a general block diagram of an image display device that includes the image display control apparatus according to the first embodiment. As shown in FIG. 1, an image display device 100 includes an image input unit 10, an image storing unit 20, an image information database 30, a preference-level calculating unit 40, a preference level database 50, a display-and-operation control unit 60, a display-output unit 70, and a user operation unit 80.

As shown in FIG. 1, an image display control apparatus 200 is configured to include the image information database 30, the preference-level calculating unit 40, the preference level database 50, and the display-and-operation control unit 60.

The image input unit 10 receives an image by using a digital camera, a video camera, an image viewer, a personal computer, a cellular phone with camera, a disk, a memory card, a scanner, and the like, or downloading from the Internet. The data format of the image can be bit map, joint photographic experts group (JPEG), graphics interchange format (GIF), or the like, and is not particularly limited.

The image storing unit 20 receives the image data from the image input unit 10 and stores therein the image data.

The image information database 30 stores therein image information about the image, simultaneously with when the image is stored in the image storing unit 20. Configuration of the image information database 30 will be described later with reference to FIG. 12. For example, if the image is shot by a digital camera, the image information includes a shooting date-and-time of the image, a shooting location, a comment, and the like, and in a case of other images, the image information includes a storing date of the image, a comment on the image, and the like.

The preference-level calculating unit 40 calculates a preference level for the image with respect to each user based on viewing time for the image by each user (data on time in a viewing history of the image). A method of calculating the preference level will be described later as an algorithm for renewing the preference level with reference to FIG. 10.

The preference level database 50 stores therein the preference level calculated by the preference-level calculating unit 40 with respect to each user. The preference level is to be used by the display-and-operation control unit 60, when a display mode is for user's preferred image. Configuration of the preference level database 50 will be described later with reference to FIG. 13.

The display-and-operation control unit 60 receives a signal that indicates an operation state operated by the user from the user operation unit 80, and controls the display-output unit 70 about image display, display of a graphical user interface (GUI), and the like. The display-and-operation control unit 60 displays user's preferred images onto the display-output unit 70 by using the preference level calculated by the preference-level calculating unit 40.

The display-output unit 70 is a display device, such as a cathode ray tube (CRT) display, a liquid crystal display (LCD), or a plasma display panel (PDP).

The user operation unit 80 includes a keyboard, a mouse, a voice input device, and the like, that are operated by a user, and outputs a signal that indicates an operation state of the operations performed by the user to the display-and-operation control unit 60.

[Functional Explanation About Image Display Device 100]

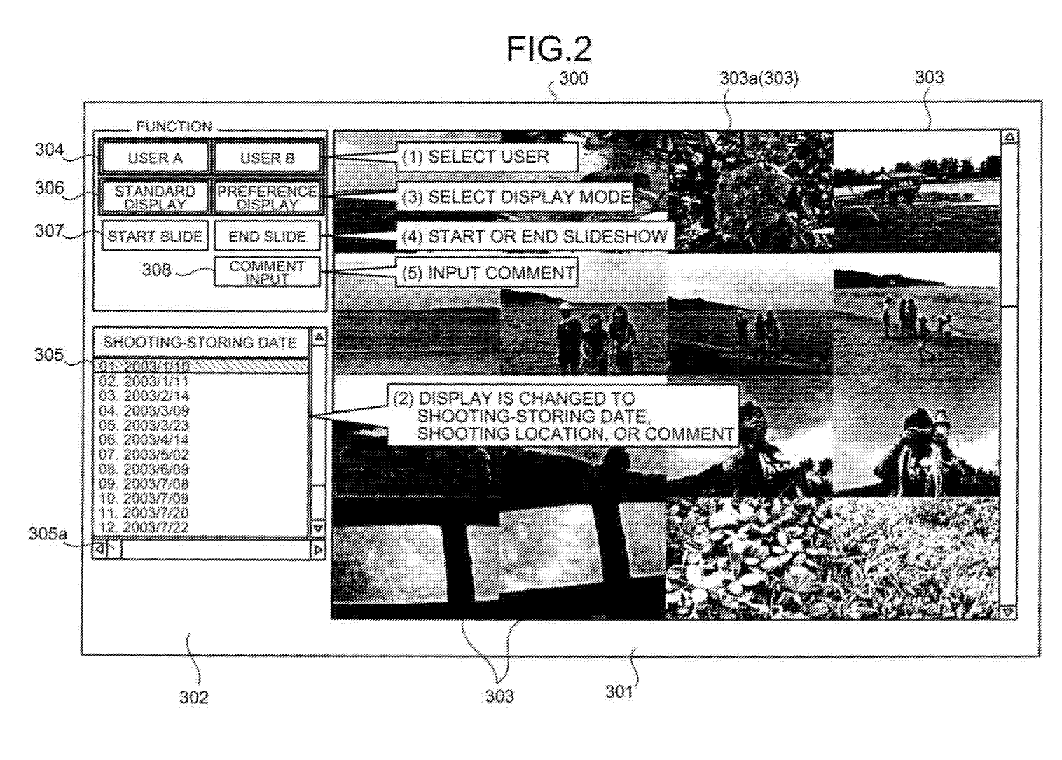

Next, functions of the image display device 100 are explained below with reference to FIG. 2.

FIG. 2 depicts a display example of images, buttons, and a list that are displayed on a screen of the display-output unit 70.

As shown in FIG. 2, a screen display unit 300 in the display-output unit 70 includes an information screen 301 and an operation screen 302, and the information screen 301 displays thumbnails 303. The operation screen 302 displays user selecting buttons 304, a list display section 305, display-mode selecting buttons 306, slideshow starting-and-ending buttons 307, and a comment input button 308.

The user selecting buttons 304 are selected by a user via the user operation unit 80 to specify the user who will view images on the screen display unit 300. If a user A selects “USER A” from the user selecting buttons 304 by using the user operation unit 80, a viewing environment of the screen display unit 300 is switched to that for the user A. As the user A selects the user A's own viewing environment by selecting from the user selecting buttons 304, images preferred by the user A are displayed on the information screen 301 based on data that indicate preference levels of the user A in the preference level database 50.

In FIG. 2, the user selecting buttons 304 are configured to select either the user A or a user B, however, buttons can be configured to select one user from a list of three or more users. Moreover, selection of the user can be performed by using voice recognition or other methods instead of operation on the screen.

The list display section 305 displays a list of shooting-storing dates of images. In the list display section 305, if the image is shot by the user such as a photograph taken with a digital camera, the date of shooting the image is displayed. If the image is obtained from a media, the Internet, or the like, by the user, the date of storing the image into the device is displayed on the list. Information about the shooting date-and-time of the image shot by the user is generally available without fail, so that a list of dates can be automatically created without time and effort by the user.

In the list display section 305, in addition to the information about the shooting-storing date of the image, for example, the user can add related information such as “XXX tour” to the image shot by the user to make it easier to understand. Likewise, in the list display section 305, an image that is obtained from the Internet can be given a name for indicating contents of the image, for example, “image at Monte Carlo Rally”.

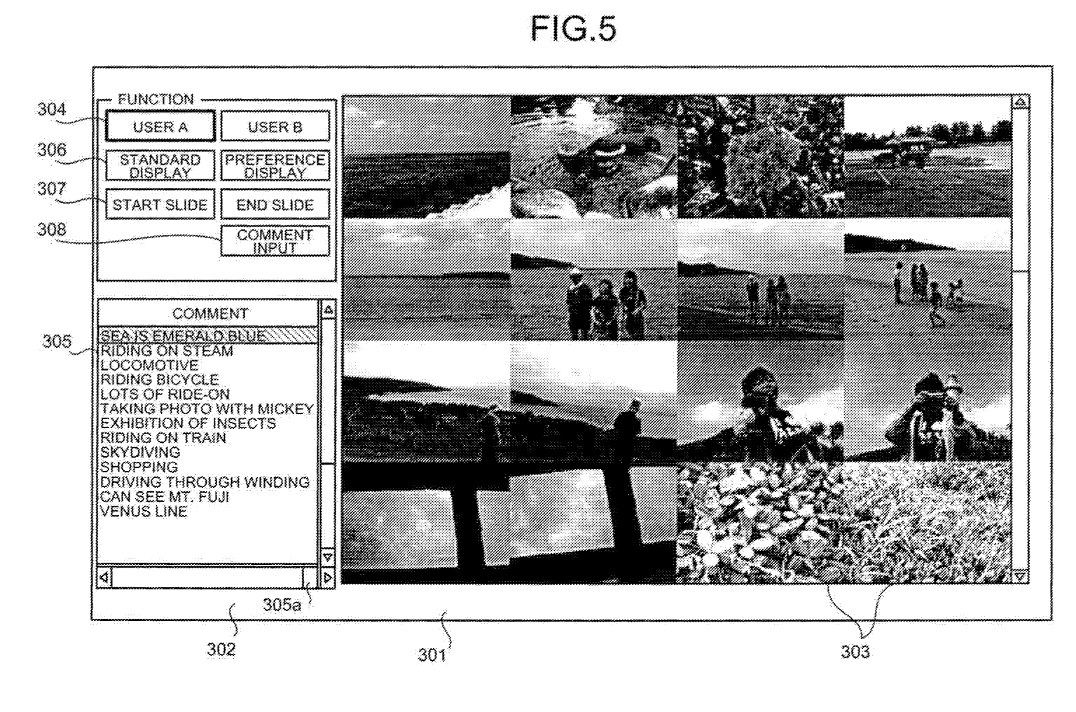

Each of FIGS. 4 and 5 depicts states in which a slide bar 305a in the list display section 305 shown in FIG. 2 is slid to the right via the user operation unit 80 operated by the user. As shown in FIGS. 4 and 5, information about a shooting location of the image in the Exchangeable image file format (Exif), which is a data format for digital camera, or comment information about the image that is input by a user to comment on the image, if such information is available, can be displayed in the list display section 305.

The information about the shooting-storing date, the shooting location, and the comment information, with respect to each shooting-storing date, which are displayed in the list display section 305 in respective states as shown in FIGS. 2, 4, and 5, are recorded in the image information database 30 (FIG. 12). When the image display device 100 is booted up, the display-and-operation control unit 60 causes the list display section 305 to display the information in the image information database 30.

The user selects a subject (shooting-storing date) that the user desires to view from the list displayed in the list display section 305 by using the user operation unit 80, so that the information screen 301 displays the thumbnail images 303 in relation to the selected subject (shooting-storing date). In the example shown in FIG. 2, the shooting-storing date 2003/1/11 with a serial number 02 is selected from the list display section 305 as a subject desired to view, and the information screen 301 displays the thumbnail images 303 of a plurality of images that are stored or shot on that date (2003/1/11).

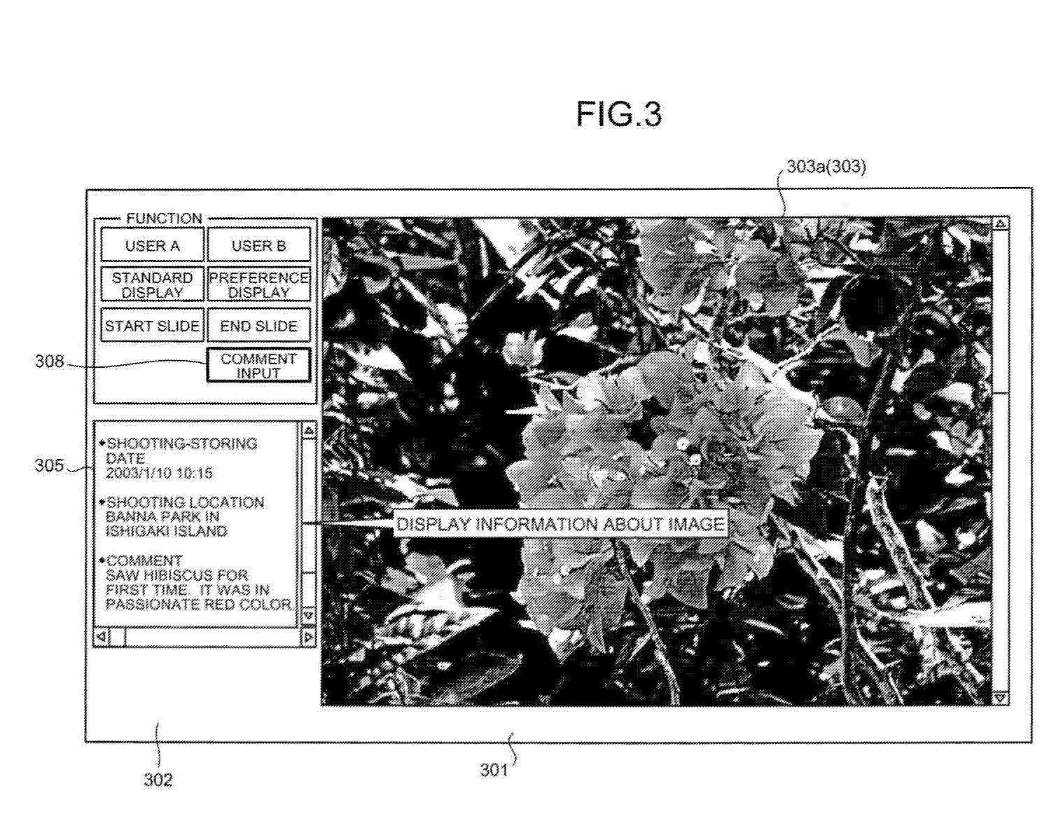

If the user selects an image 303a, which the user desires to view, from the thumbnail images 303 displayed on the information screen 301 in FIG. 2 by using the user operation unit 80, the selected image 303a is displayed in an enlarged form as shown in FIG. 3. In the first embodiment, such state in which the image is displayed in the enlarged form is described as a state in which the image is being viewed. While the image is being viewed, the list display section 305 switches to information about the selected image 303a to display the shooting date-and-time, and if available, the shooting location, and the comment information.

The information about the shooting-storing date-and-time, the shooting location, and the comment information per image displayed in the list display section 305 in the state as shown in FIG. 3 are recorded in the preference level database 50 (FIG. 13). When the image 303a desired to view is selected from the thumbnail images 303 displayed on the information screen 301, the display-and-operation control unit 60 causes the list display section 305 to display the above information about the selected image 303a by referring to the preference level database 50.

By using the user operation unit 80, the user can return the image 303a from the enlarged display as shown in FIG. 3 to the image 303 in the initial thumbnail display as shown in FIG. 2. Here, a time from when displaying the image 303a in the enlarged form until when returning to the initial thumbnail display is a viewing time, which is to be used for calculating a preference level as described later.

In FIG. 2, as one of the display-mode selecting buttons 306 is selected via operating the user operation unit 80, display modes of the thumbnail images 303 displayed on the information screen 301 are switched. The display modes include a standard mode in which thumbnails are displayed in ascending order of date-and-time of the shooting-storing date, and a preference mode in which thumbnails are displayed in descending order of preference level. Display order is not limited to these. Information about the preference level per image is recorded in the preference level database 50 (FIG. 13).

If the preference mode is selected with the display-mode selecting button 306, only the thumbnail images 303 in high preference levels, which will be described later, is displayed on the information screen 301. In the preference mode, the thumbnail images 303 that are presumed to be more preferred by the user are displayed on the information screen 301, so that the user can easily select preferred images from among a plurality of images stored in the image storing unit 20.

The slideshow starting-and-ending buttons 307 are selected via operating the user operation unit 80 to start and to stop a slideshow of the thumbnail images 303. When the standard mode is selected with the display-mode selecting buttons 306, a slideshow of all of the thumbnail images 303 is performed in ascending order of date-and-time of the shooting-storing date. By contrast, when the preference mode is selected with the display-mode selecting buttons 306, a slideshow of only images in high preference levels among the thumbnail images 303 is performed. The slideshow is ended with an ending button of the slideshow starting-and-ending buttons 307, and returns to the initial thumbnail display as shown in FIG. 2. The slideshow aims to provide a more comfortable environment for viewing images for the user, and can be omitted.

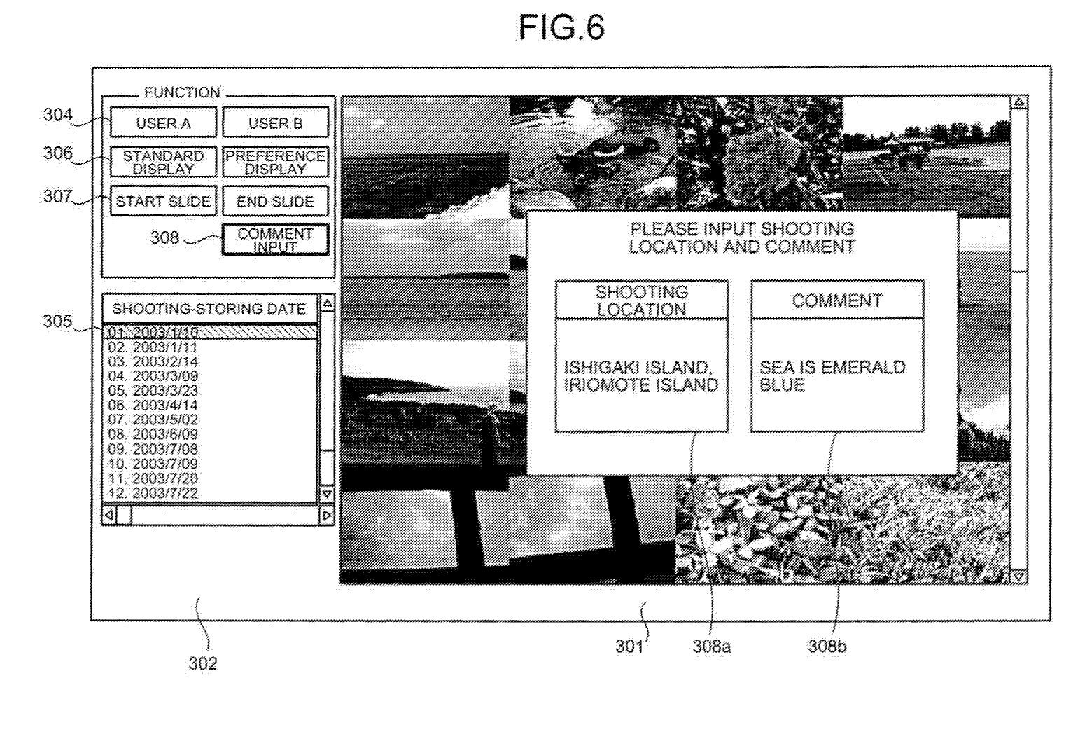

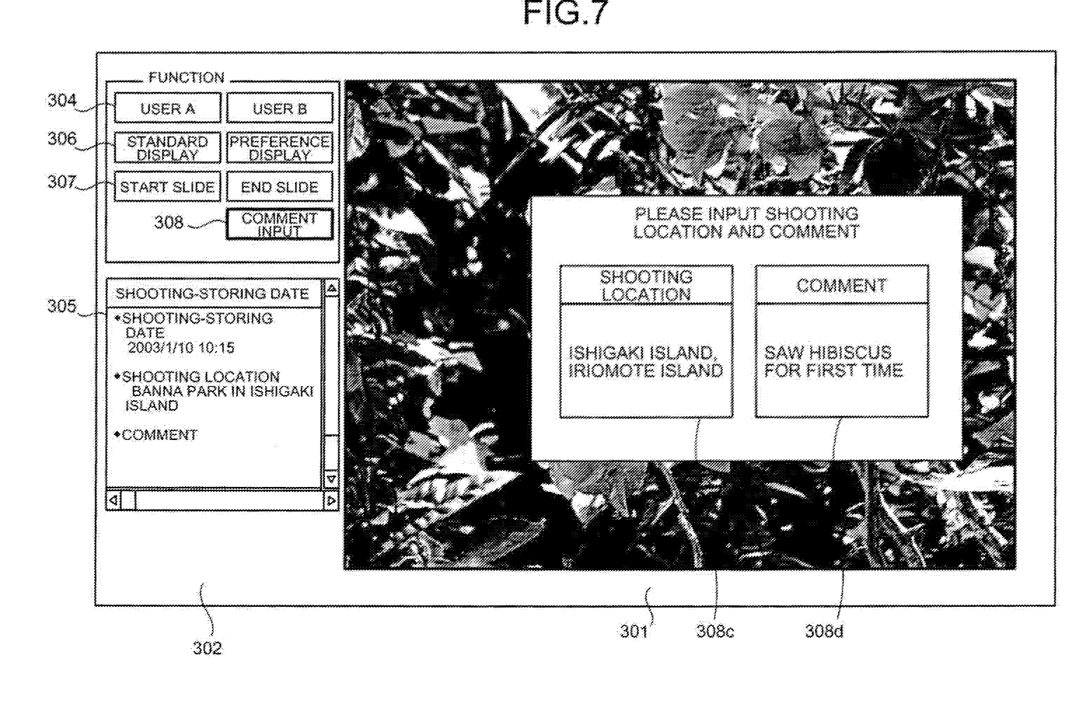

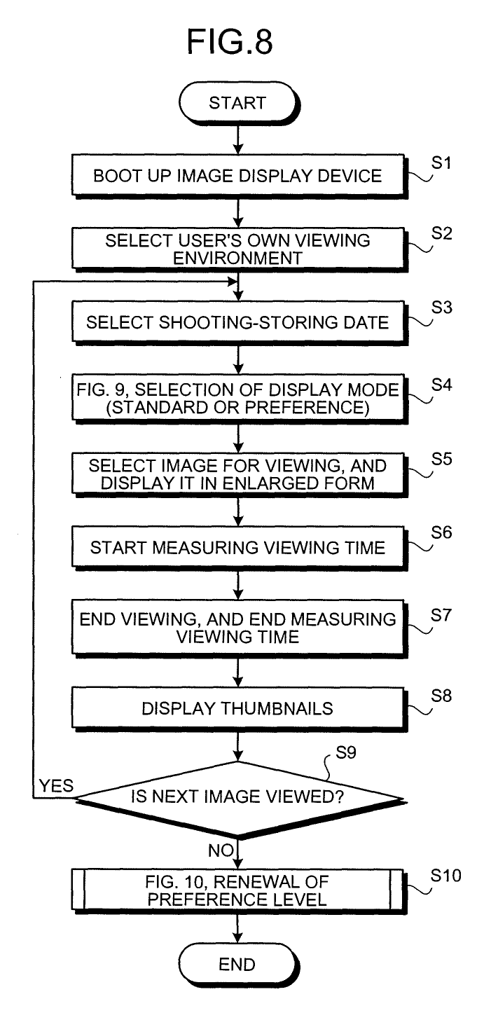

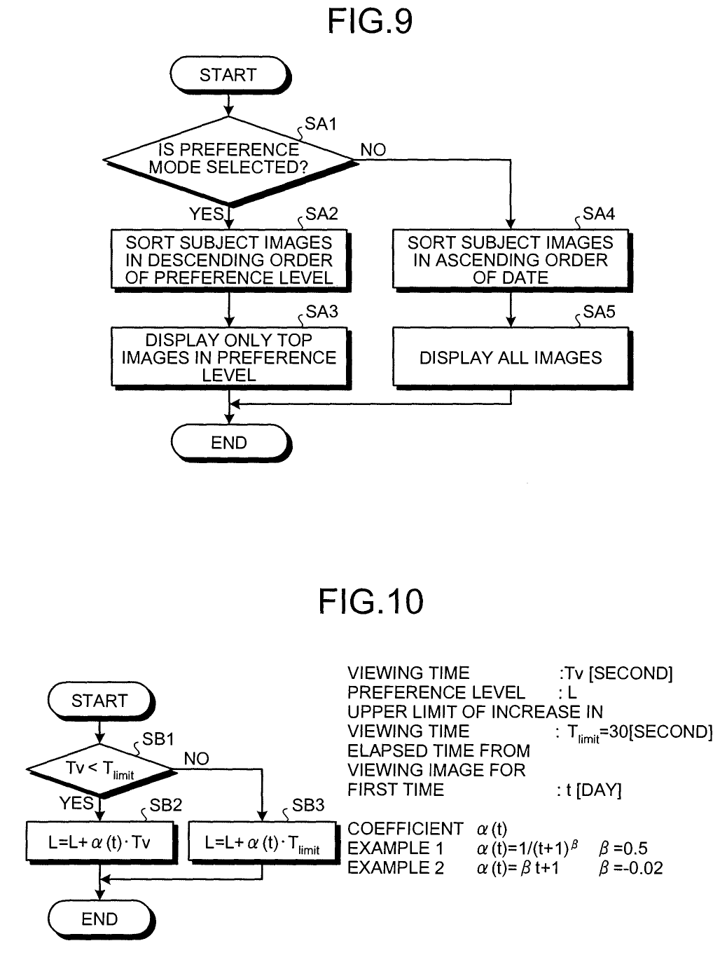

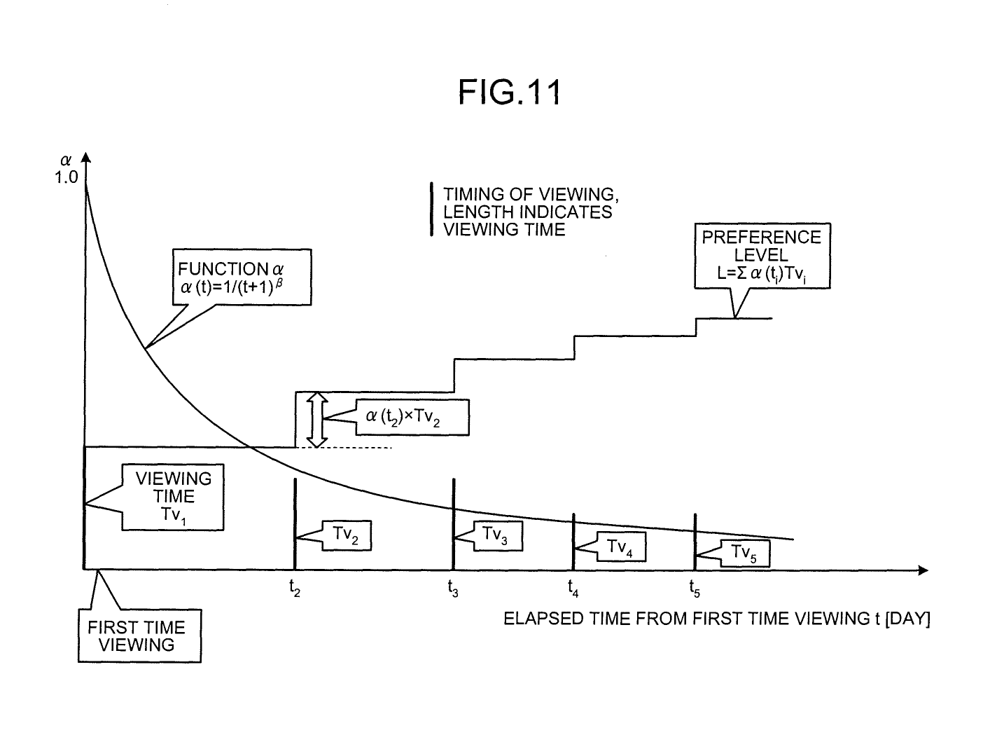

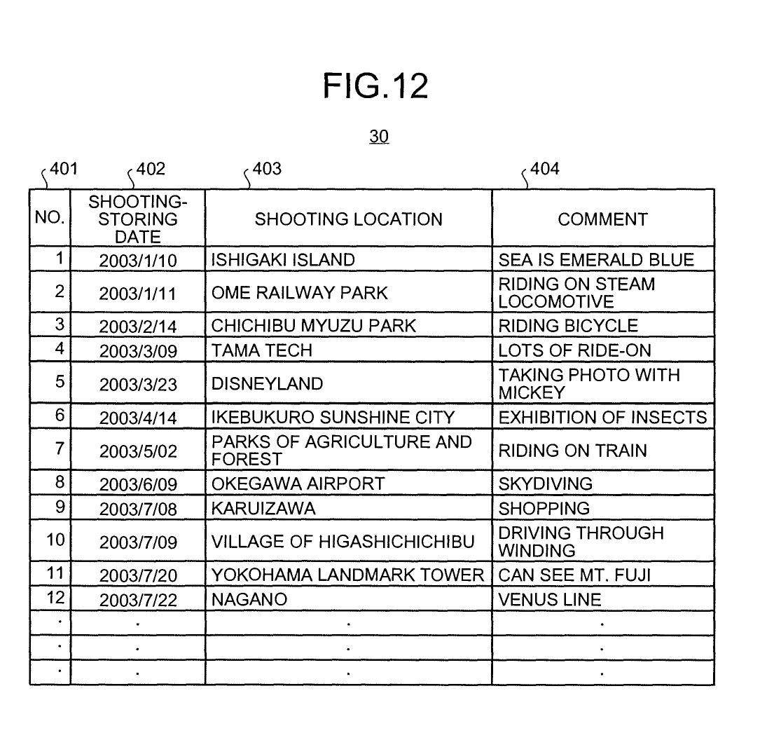

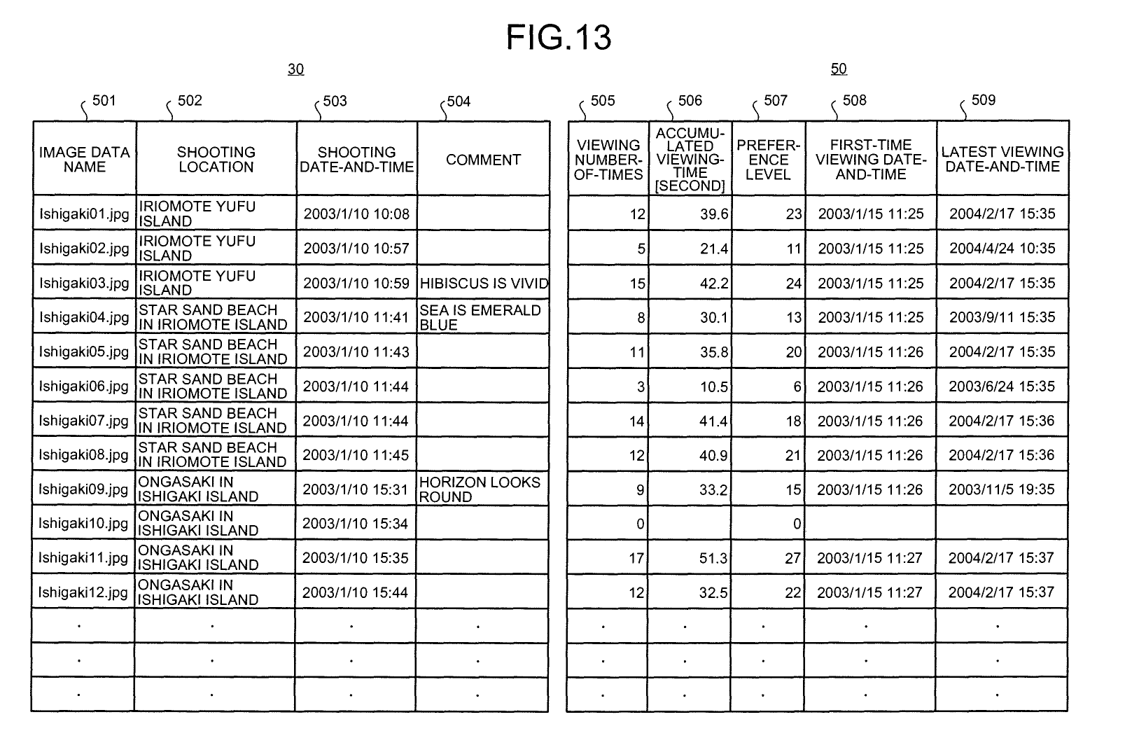

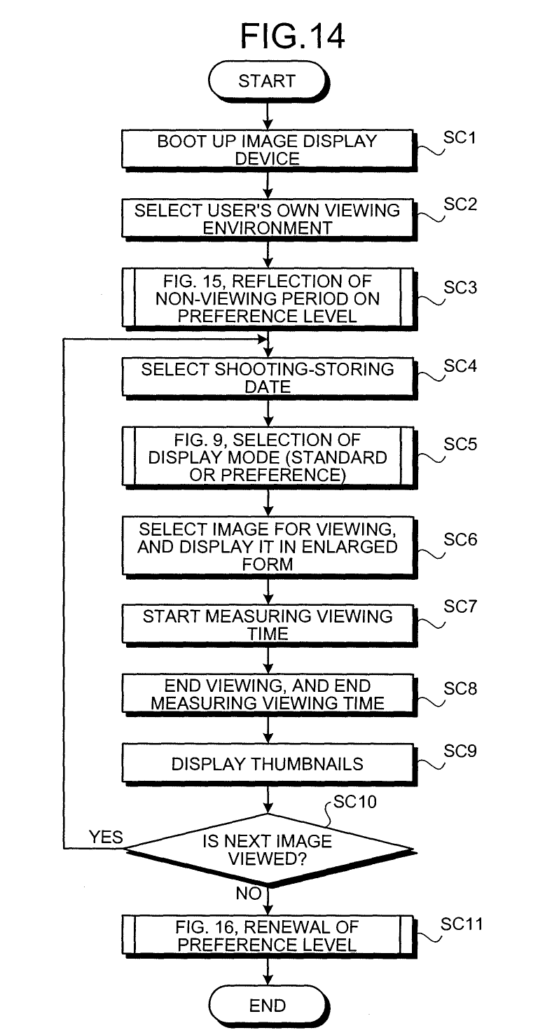

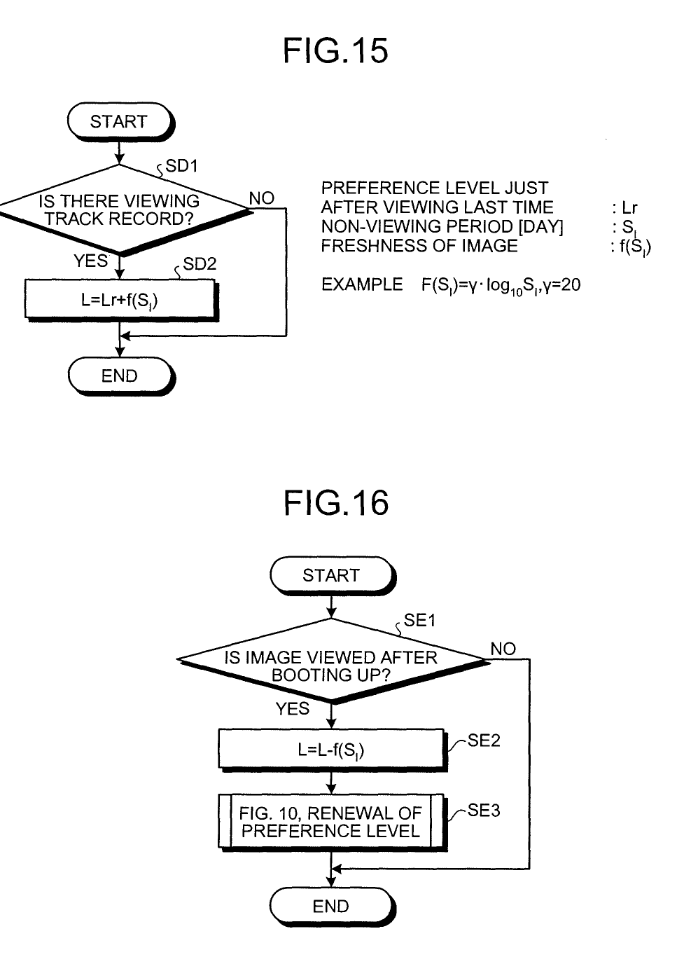

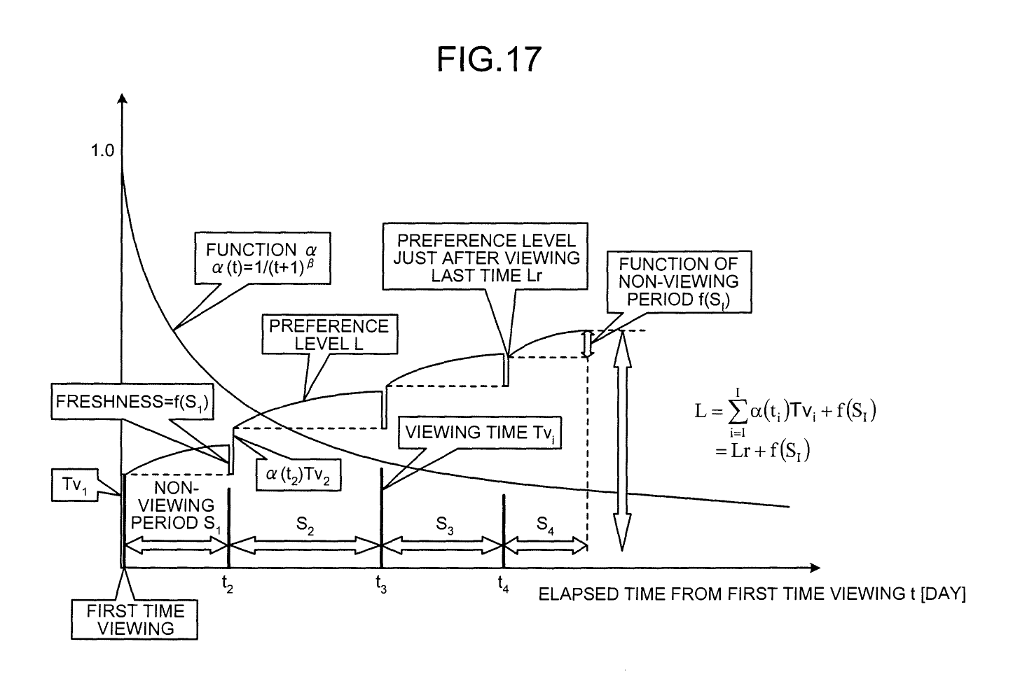

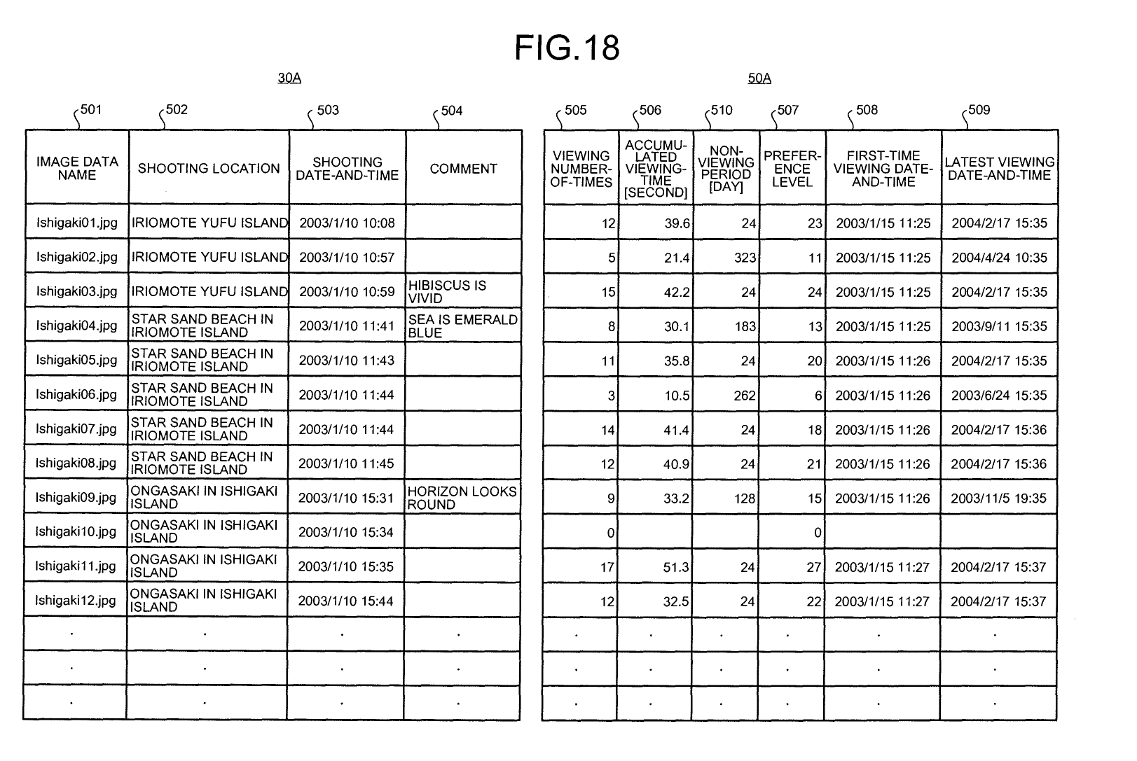

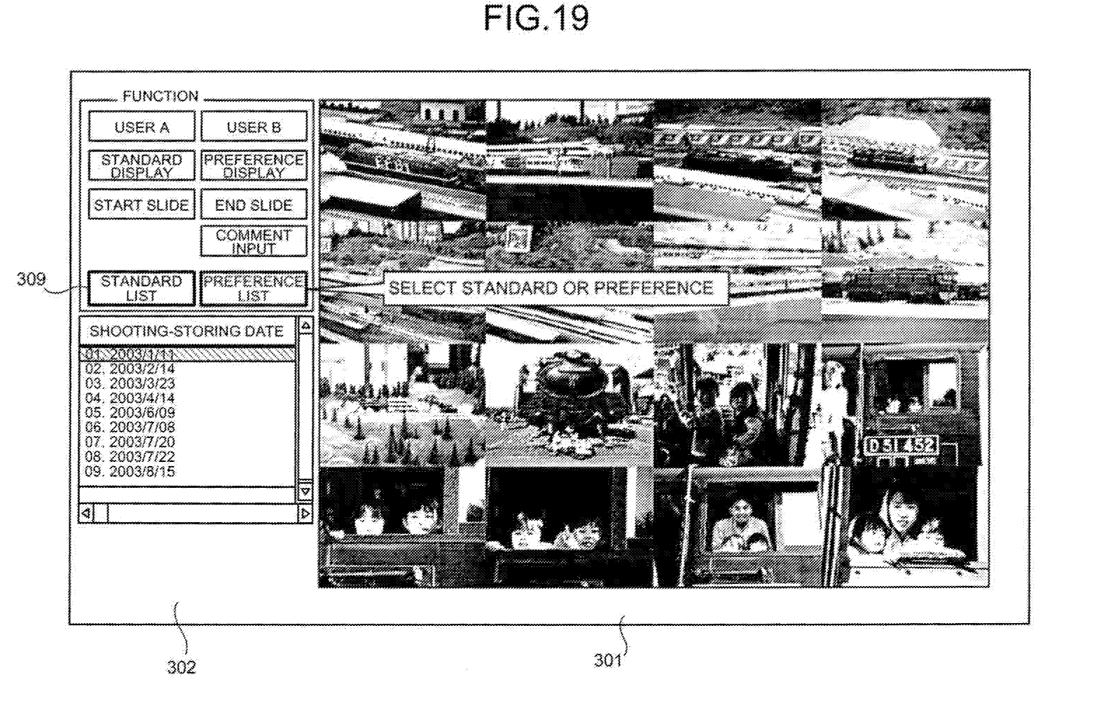

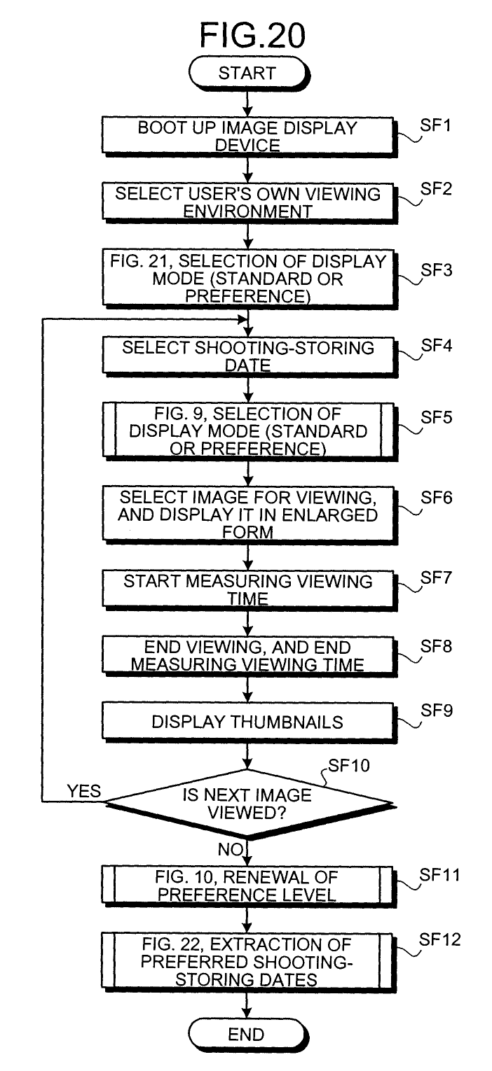

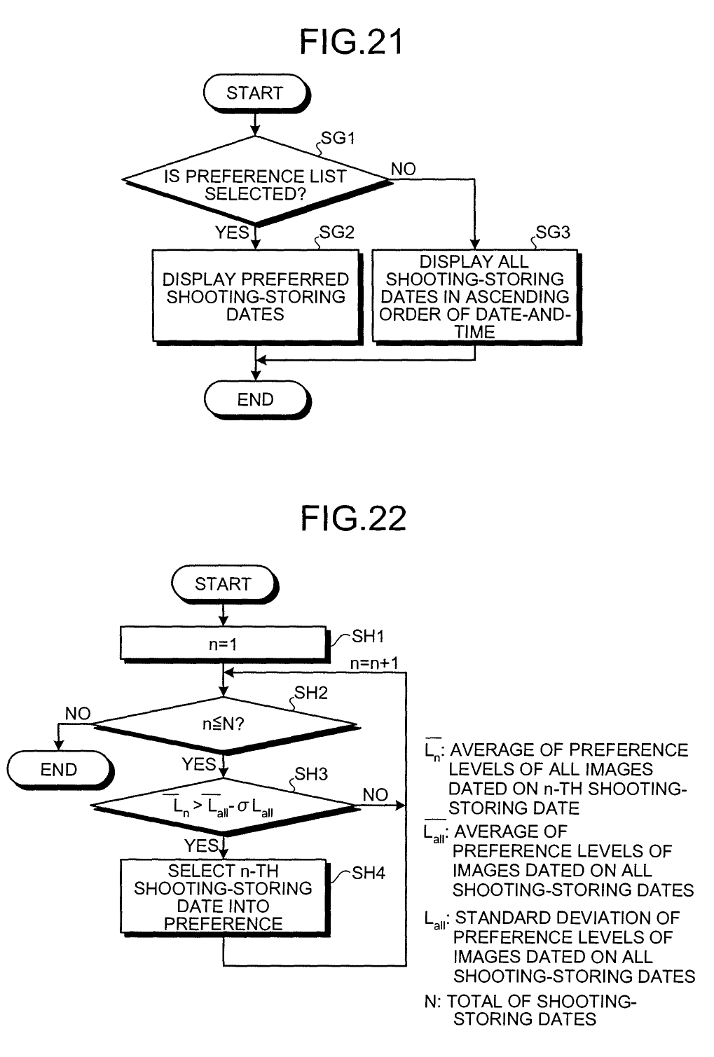

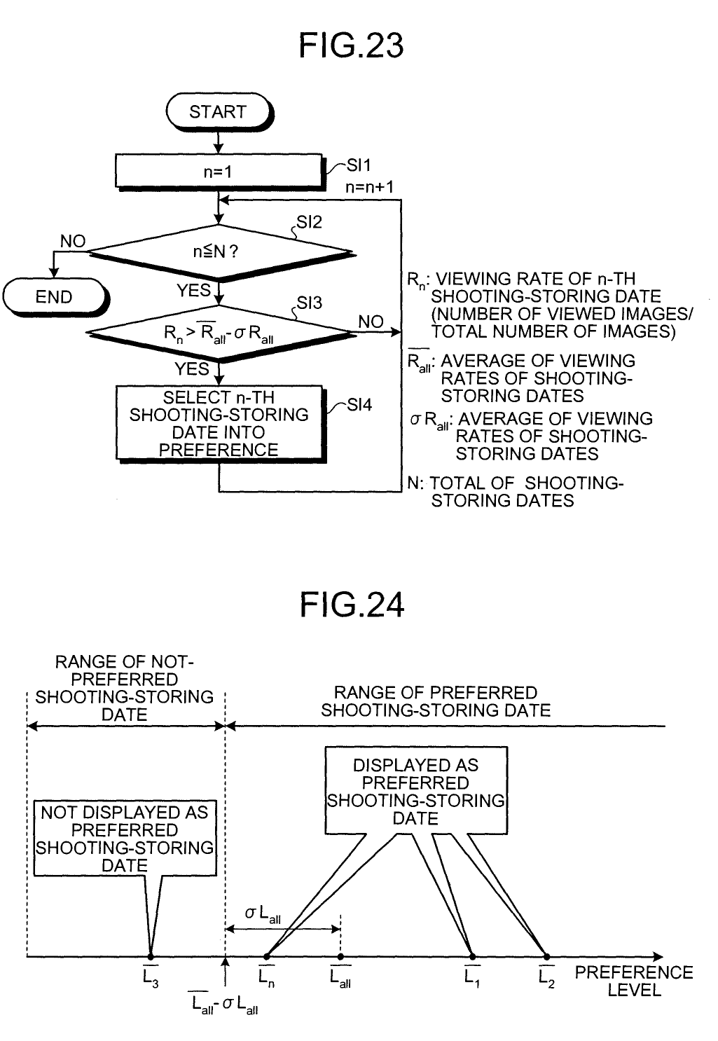

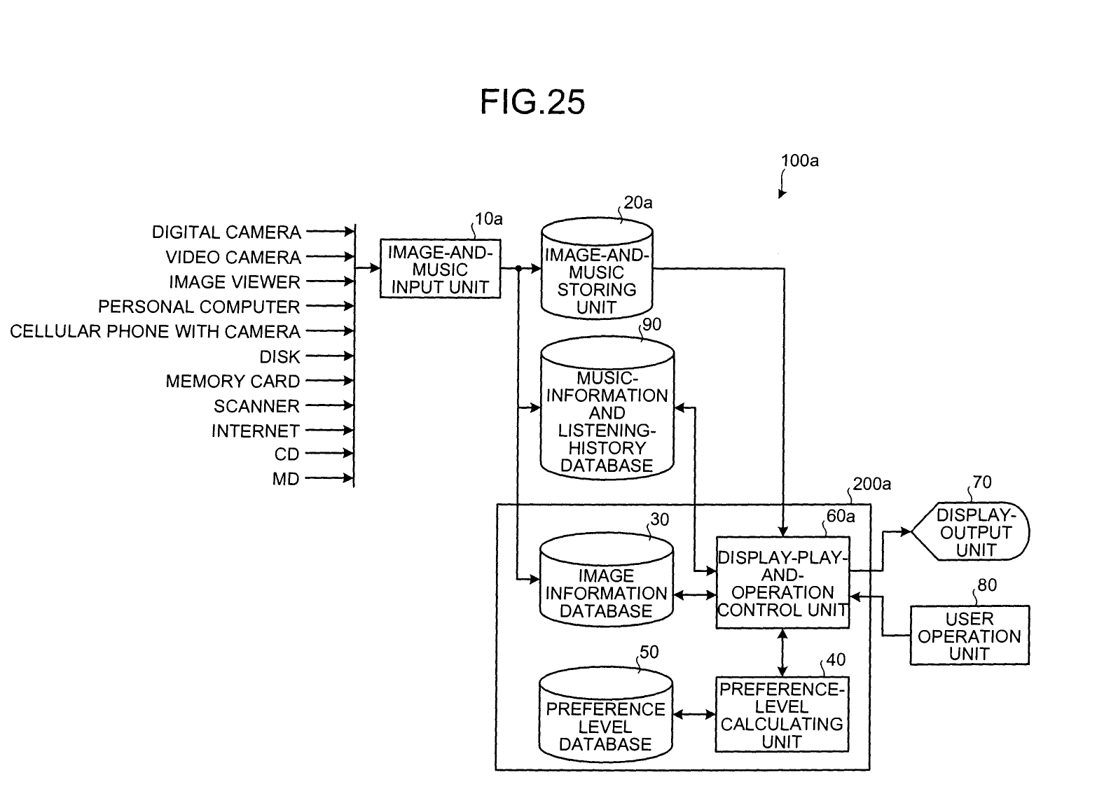

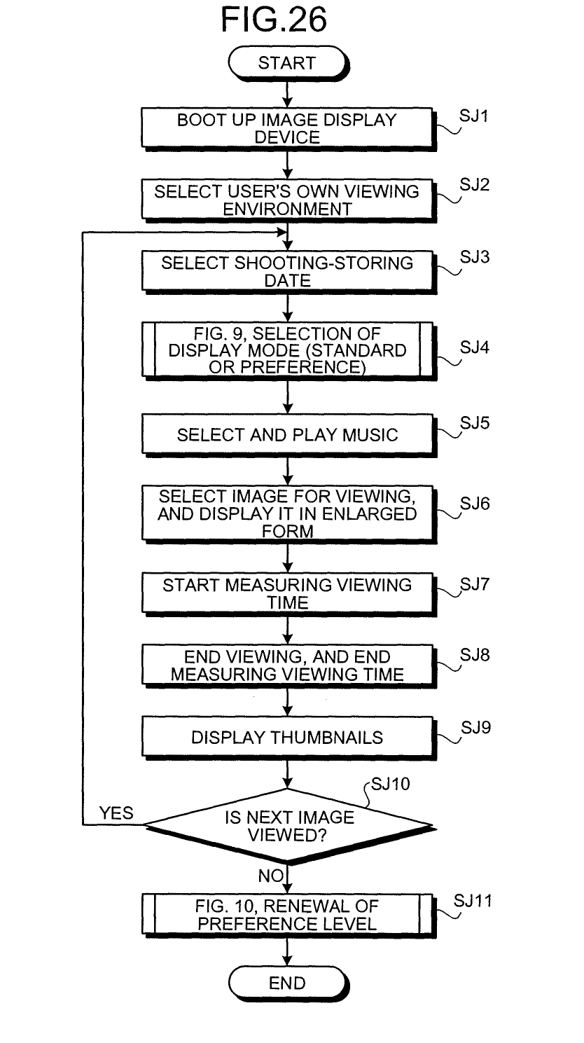

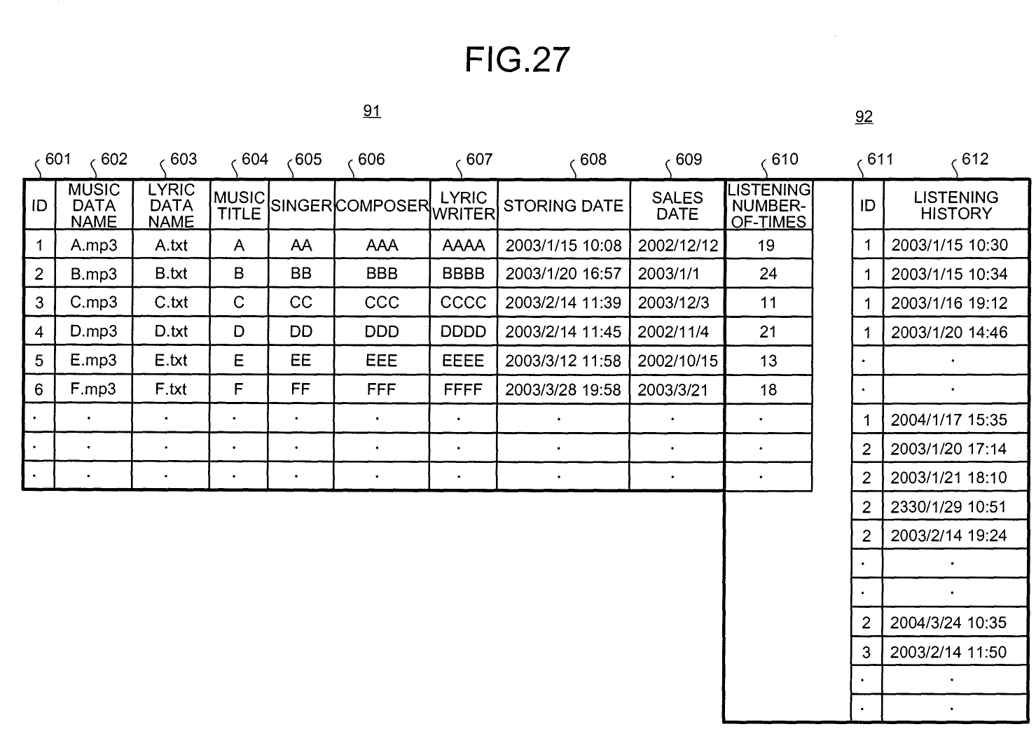

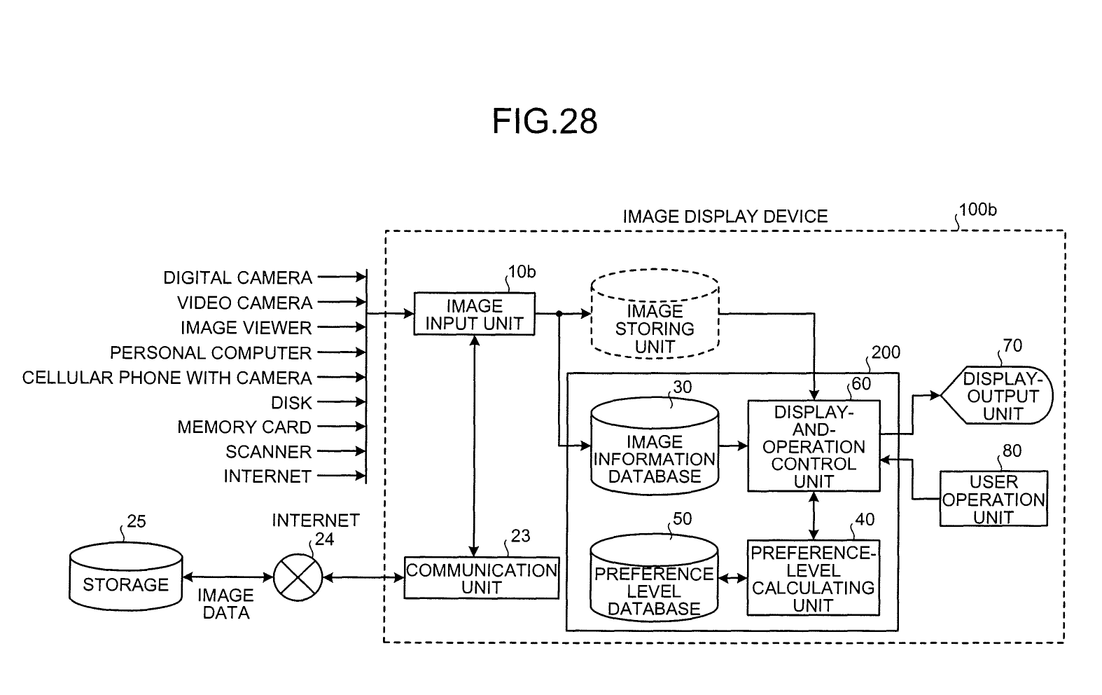

As the comment input button 308 is operated via the user operation unit 80, is turned to a mode in which the user inputs information about the image. If information such as the shooting location of an image is not automatically input, the user can input the shooting location, comment information, and the like about the image, by turning into the mode in which the user can input information as shown in FIGS. 6 and 7.

As shown in FIG. 6, in a state in which thumbnails dated on selected shooting-storing dates are displayed, input columns 308a and 308b in which a shooting location and a comment are to be input about images dated on the selected shooting-storing dates are displayed. When the user input characters into the input columns 308a and 308b by using the user operation unit 80, information about the shooting location and the comment in the image information database 30 (FIG. 12) is renewed, the information is reflected and displayed in the list display section 305, as shown in FIGS. 4 and 5.

Likewise, in a state in which the image is displayed in the enlarged form as shown in FIG. 7, when the comment input button 308 is operated, input columns 308c and 308d, in which a shooting location and a comment are to be input for the selected individual image, are displayed. When the user input characters into the input columns 308c and 308d by using the user operation unit 80, information about the shooting location and the comment in the preference level database 50 (FIG. 13) is renewed, the information is reflected and displayed in the list display section 305 when the image is displayed in the enlarged form on the information screen 301.

As shown in FIGS. 6 and 7, input of information by the user aims to provide a more comfortable environment for viewing images, and can be omitted.

[Operational Algorithm for Image Display Device 100]

Next, an operational algorithm for the image display device 100 is explained with reference to FIG. 8.

To begin with, as shown at step S1, the image display device 100 boots up in response to operation of the user operation unit 80 by the user. Next, as shown at step S2, the user operates the user selecting buttons 304 so that the viewing environment for the user is selected. As the viewing environment for the user is selected, the viewing environment is changed to the one for the user that uses the preference level of the user (the preference level database 50 that will be described later (FIG. 13)), or a preference level database section 52 in the preference level database 50, is switched to the user's one).

Next, as shown at step S3, the user selects one from among the shooting-storing dates displayed in the list display section 305. The display-and-operation control unit 60 then refers to the preference level database 50 and the image storing unit 20 to display thumbnails of a plurality of images with the selected shooting-storing date on the information screen 301.

Next, as shown at step S4, the user operates the display-mode selecting buttons 306 so that the display mode is selected. In accordance with a selected result, thumbnails of images to be displayed on the information screen 301 are switched. Details of step S4 will be explained later as an algorithm for selecting the thumbnail-image display mode (FIG. 9).

Next, as shown at step S5, the user operates the user operation unit 80 to select an image that the user desires to view from among the images displayed in thumbnails. After the image is selected by the user, the display-and-operation control unit 60 displays the selected image in an enlarged form on the information screen 301 (step S5).

After the image selected by the user is displayed in the enlarged form, the preference-level calculating unit 40 measures a time from when the image is displayed in the enlarged form until when the image is returned to the initial thumbnail display as a viewing time (steps S6 to S8).

Next, the display-and-operation control unit 60 determines whether the user views the next image based on operation of the user operation unit 80 by the user (step S9). As a result of the determination, if the next image is to be viewed, operations from the step S3 are repeated.

As a result of the determination at step S9, if the next image is not be viewed, the preference-level calculating unit 40 renews the preference level in the preference level database 50 by using the viewing time measured at steps S6 and S7 (step S10). Details of step S10 will be described later as the algorithm for renewing the preference level (FIG. 10).

[Algorithm for Selecting Thumbnail-Image Display Mode (Standard or Preference)]

Next, the algorithm for selecting the thumbnail-image display mode (standard or preference) is explained with reference to FIG. 9.

At step S4 in FIG. 8 described above, when the user selects from the display-mode selecting buttons 306, as shown at step SA1 at first, the display-and-operation control unit 60 determines whether the preference mode is selected. As a result of the determination, if the preference mode is selected (Yes at step SA1), the display-and-operation control unit 60 refers to data on preference levels in the preference level database 50, sorts the images with the shooting-storing dates selected at step S3 in FIG. 8 in descending order of preference level (step SA2), and causes the information screen 301 to display only the top x images in the preference levels (step SA3). Other methods can be used in terms of sorting order.

By contrast, if the standard mode is selected by the user (No at step SA1), the display-and-operation control unit 60 refers to data on shooting-storing date-and-time in the image information database 30, sorts the images with the shooting-storing date selected at step S3 in FIG. 8 in ascending order of shooting-storing date-and-time (step SA4), and causes the information screen 301 to display all of the images (step SA5). Other methods can be used in terms of sorting order.

[Algorithm for Renewing Preference Level]

Next, the algorithm for renewing the preference level is explained with reference to FIG. 10.

To begin with, as shown at step SB1, the preference-level calculating unit 40 determines whether a viewing time Tv measured at steps S6 and S7 in FIG. 8 exceeds Tₗᵢₘᵢₜ, which is an upper limit of increase in the viewing time per once viewing. The reason why performing this determination is to suppress false determination as like the user is continuously viewing an image (for long hours), despite that the user is not actually viewing the image, because the user is off from the front of the display-output unit 70 (the image display device 100), meanwhile the image has been displayed in an enlarged form for viewing by the user (step S5 in FIG. 8).

As a result of the determination at step SB1, if the viewing time Tv is lower than the upper limit Tₗᵢₘᵢₜ (Yes at step SB1), the preference-level calculating unit 40 adds a product of the viewing time Tv multiplied by a coefficient α(t) to the preference level before viewing (step SB2).

Here, the coefficient α(t) is defined by a function of an elapsed time t [days] since the image is viewed for the first time until the date-and-time when the image is viewed this time, as shown in FIG. 11. In the first embodiment, a simple decreasing function, such as a function α(t)=i/(t+1)^{β}, is used. The reason for using the simple decreasing function is because it is expected that a preferred image is determined with almost first impressions, and it is proposed to suppress an unrestricted increase in the preference level caused by accumulating preference levels.

As shown in FIG. 10, for example, 0.5 can be used as a value of β, where α(t)=1/(t+1)^{β}. In stead of the equation α(t)=1/(t+1)^{β}, an equation α(t)=βt+1 can be used, where the value of β can be −0.02.

By contrast, if viewing time Tv is the upper limit Tₗᵢₘᵢₜ (No at step SB1), the preference-level calculating unit 40 adds a product of the upper limit Tₗᵢₘᵢₜ of the increase in the viewing time per once viewing multiplied by the coefficient α(t) to the preference level before viewing (step SB3). After the preference level L is obtained at step SB2 or step SB3, a value of the preference level in a preference level recording area 507 in the preference level database 50 (FIG. 13) is renewed (step S10 in FIG. 8).

FIG. 11 depicts changes in the preference level. The preference level is calculated in accordance with L=Σα(tᵢ)Tvᵢ (where i is the i-th time of viewing from the first time viewing). At each bar of Tvᵢ shown in FIG. 11, the position on the x axis indicates timing of the i-th time viewing from the first time viewing, and the length in the y axis direction indicates the viewing time at the i-th time. FIG. 11 depicts that an unrestricted increase in the preference level is suppressed by using the simple decreasing function as the coefficient α(t).

Next, the image information database 30 and the preference-level calculating unit 40 are explained with reference to FIGS. 12 and 13.

In the image information database 30 shown in FIG. 12, information per shooting-storing date is recorded to display information per shooting-storing date in the list display section 305. As shown in FIG. 12, in the image information database 30, a serial number is provided per shooting-storing date, and information about the shooting location and the comment for image(s) dated on the shooting-storing date is recorded. Precisely, a serial number per shooting-storing date is recorded in a serial-number recording area 401 in the thumbnail images 303, information about shooting or storing date is recorded in a shooting-storing date recording are 402, shooting location information is recorded in a shooting-location recording area 403, and comment information is recorded in a comment recording area 404.

As shown in FIG. 13, in the image information database 30, information about the shooting location, the shooting date-and-time, and the comment is recorded per image. In the preference level database 50, information about the number of time of viewing, an accumulated viewing time, the preference level, the first viewing date-and-time, and the latest viewing date-and-time are recorded. The image information database 30 and the preference level database 50 are provided per user. However, the image information database 30 can be shared with all users. After the viewing environment is selected with the user selecting buttons 304 at step S2 in FIG. 8, in accordance with the selection, the image information database 30 and the preference level database 50 that is to be referred by the display-and-operation control unit 60 are switched.

In FIG. 13, information about data name of each image is recorded in an image data name recording area 501 in the thumbnail images 303, and information about shooting location of each image is recorded in a shooting-location recording area 502. It can be configured that the shooting location information to be recorded in the shooting-location recording area 502 is input from the image input unit 10 in a manner that the shooting location information is automatically attached to image data by using the global positioning system (GPS) in a digital camera, a cellular phone with camera, or the like; image data in the input data is recorded in the image storing unit 20; and the shooting location information in the input data is recorded in the preference level database 50. If the shooting location information is not able to be automatically obtained, it can be input by the user as shown in FIG. 7.

In FIG. 13, information about the shooting date-and-time of each image is recorded in a shooting date-and-time recording area 503 in the image information database 30, and information about the comment on each image is recorded in a comment recording area 504. Information about the number of times of viewing each image is recorded in a viewing number-of-times recording area 505 in the preference level database 50; information about an accumulated viewing time [second] for each image is recorded in an accumulated viewing-time recording area 506; information about the preference level L to each image is recorded in the preference-level recording area 507; information about the date-and-time of viewing each image in an enlarged display form for the first time is recorded in a first-time viewing date-and-time recording area 508; and information about the latest viewing date-and-time for each image in an enlarged display form is recorded in a latest viewing date-and-time recording area 509. After the image is viewed, information in each of recording areas 505 to 509 in the preference level database 50 is renewed respectively (see step S10 in FIG. 8).

As described above, according to the first embodiment, the degree of preference (preference level) for an image is calculated basically by using the viewing time for the image by the user. Therefore, differing from Patent Document 1, if the user selects the image by fault and re-selects another image immediately, the degree of preference to the selected image is not increased. By using the preference level according to the first embodiment, user's preference to image can be more precisely reflected. Moreover, the degree of preference to each image can be differentiated in accordance with the preference level, so that display of images can be devised such as image display in descending order of degree of preference when displaying images.

Furthermore, according to the first embodiment, the upper limit of increase in the preference level per once viewing is set. This avoids irrelevant increase in the preference level caused by interruptive absence by the user while viewing, thereby reflecting preference of the user more precisely in the preference level.

Furthermore, in the first embodiment, the preference level is obtained by multiplying the viewing time by a coefficient that uses the simple decreasing function with a variable of the elapsed time from the first time viewing. The reason for this is because it is considered that a preferred image is determined based on impressions right after the first time viewing, and it is proposed to reduce contribution to the preference level from a viewing time when viewing the image after an elapse from the first time viewing. By using the simple decreasing function, an unrestricted increase in the preference level is avoided. Moreover, because the preference level is almost determined based on the viewing time right after the first time viewing, degrees of preferences can be compared between images with different storing periods.

In addition to the viewing time for an image viewed by the user, the preference level for an image can be calculated by using the number of times of printing, or the number of times of transmitting, because the image that is printed or transmitted many times are presumed that the user has a high preference to the image.

### Second Embodiment

Next, a second embodiment according to the present invention is explained with reference to FIGS. 14 to 18.

In the second embodiment, explanations about part common to the first embodiment are omitted.

In the second embodiment, the conception of the preference level for an image includes freshness of the image. When calculating the preference level, in addition to the viewing time Tv for the image, a non-viewing period (data on time in a viewing history of the image) is taken into account. Meaning of the non-viewing period is explained below.

For example, a user views a photograph taken by a digital camera just after the user stores the photograph into a recording device, and views previously stored photographs when storing a new photograph next time, so that a viewing pattern is presumed to be temporally discrete. At least, it is presumed that it is rare to view the same photograph everyday. Taking this point into account, if a non-viewing period of an image becomes long, the user forgets an event of viewing the image and an impression of the image when viewing, therefore it is assumed that freshness of the image is increased. A control is performed to display not only an image with a long viewing time but also an image with a long non-viewing period and high freshness to the user. This results in an effect that reminds the user about presence of such photograph, and avoids tiring the user with displaying nothing but familiar photographs.

FIG. 14 is an operational algorithm for the image display device 100 according to the second embodiment. In FIG. 14, steps SC1 and SC2 are similar to steps S1 and S2 in FIG. 8 respectively; and steps SC4 to SC11 are similar to steps S3 to S10 in FIG. 8 respectively; so that explanations about these are omitted.

At step SC3 in FIG. 14, a preference level in which the non-viewing period is reflected on the preference level L (Lr in FIG. 15), which is obtained at the previous step SC1 in accordance with the flowchart shown in FIG. 10, is obtained. A method of obtaining the preference level will be described later in detail with reference to FIG. 15. To begin with, the preference-level calculating unit 40 determines whether the image has a viewing track record (step SD1), as a result of the determination, only if the image has a viewing track record (step SD-Y), the preference-level calculating unit 40 obtains a preference level in which the non-viewing period is reflected (step SD2).

In other words, at step SC3 in FIG. 14, after the user selects the user's own viewing environment (step SC2), the preference level is renewed by reflecting the non-viewing period (step SD2) only on the image(s) that has a viewing track record viewed by the user (Yes at step SD1 in FIG. 15). After that, a shooting-storing date is selected (step SC4). If the preference mode is selected (step SC5), thumbnails of preferred images are displayed based on the preference level in which the non-viewing period is reflected (step SA3 in FIG. 9 at step SC5). Accordingly, an image that has the viewing track record (Yes at step SD1), and that has been not viewed for a long time (step SD2) is preferentially displayed (step SA3 in FIG. 9 at step SC5 in FIG. 14).

The algorithm for renewing the preference level shown in FIG. 15 performed at step SC3 in FIG. 14 is executed right after the image display device 100 is booted up. Precisely, the image display device 100 is booted up (step SC1), the user selects the user's own viewing environment (step SC2); so that presence or absence of a viewing track record and a non-viewing period, from the previous viewing until the image display device 100 is booted up this time, for each of all images in relation to the user, are found; and then the algorithm for renewing the preference level shown in FIG. 15 is executed.

Here, the non-viewing period is obtained every time when the image display device 100 is booted up and the viewing environment is selected, and means the number of dates from the date when the image is previously displayed in an enlarged form (viewed) until when the image display device 100 is booted up this time.

According to the algorithm for renewing the preference level shown in FIG. 15, the preference-level calculating unit 40 refers to the preference level database 50 (FIG. 18), and determines presence or absence of the viewing track record for each of all images by the user (step SD1); and if the image has the viewing track record (Yes at step SD1), the preference level L is renewed by adding a function f(S_{I}) to the preference level (Lr) after the previous viewing, where the function f(S_{I}) includes a non-viewing period (S_{I}) as a variable (step SD2).

The function f(S_{I}), in which the non-viewing period (S_{I}) is a variable, means freshness that the user feels to the image. Here, the preference level is such that the non-viewing period is reflected only on the image that has a viewing track record, because an image without viewing track record is not preferred image in the first place, therefore it has no meaning even if the non-viewing period is reflected on it.

As the above function f(S_{I}), for example, f(S_{I})=γ×log₁₀ S_{I} (where γ is a constant, for example, γ=20) is used. Use of such function suppresses an unrestricted increase in the preference level by a contributed portion arising from the non-viewing period, thereby avoiding a situation in which displayed preferred images are only images that have not been viewed for a long time (while a viewing time is hardly reflected).

If the user selects the preference mode (step SC5 in FIG. 14), thumbnails of preferred images are displayed by using the renewed preference level in which the non-viewing period is reflected (steps SA2 and SA3 in FIG. 9).

FIG. 16 is an algorithm for renewing the preference level after the end of viewing the image displayed in an enlarged form at steps SC6 to SC9 shown in FIG. 14. To begin with, at step SE1, the preference-level calculating unit 40 determines whether the image is displayed in an enlarged form and viewed after the image display device 100 is booted up. As a result of the determination, if the image is displayed in an enlarged form and viewed (Yes at step SE1), it is considered that freshness is decreased, and a contributed portion f(S_{I}) arising from the non-viewing period is subtracted from the preference level before viewing (step SE2). According to the algorithm shown in FIG. 10, the preference level is renewed by reflecting the viewing time at this time onto the subtracted preference level.

FIG. 17 indicates change in the preference level according to the second embodiment.

As shown in FIG. 17, in the preference level, not only the viewing time but also the non-viewing period is reflected, so that the preference level is raised in accordance with the non-viewing period S_{I}. In FIG. 17, a broken line indicates the preference level that is determined only by the viewing time as shown in FIG. 11. After the image is viewed, at step SE2 in FIG. 16, when the function of the non-viewing period f(S_{I}), which corresponds to freshness, is subtracted, the preference level L shown with a solid line in FIG. 17 declines to the level with the broken line, and then the preference level L rises again as the viewing time at this time is reflected in accordance with the operation shown in FIG. 10.

FIG. 18 depicts an image information database 30A and a preference level database 50A according to the second embodiment. In the image information database 30A, differing from the preference level database 50 according to the first embodiment shown in FIG. 13, a non-viewing period recording area 510 in which information about the non-viewing period [day] is recorded per image is provided.

As described above, according to the second embodiment, the preference level is calculated by using the viewing time and the non-viewing period. By controlling to display preferentially an image that has a long non-viewing period, there is an effect to remind the user about presence of an image that, for example, the user prefers and frequently views just after the image is stored, however, after a while, the user forgets about its presence and does not view for a while. Moreover, there is an effect that the user can enjoy viewing the images more as displayed preferred images are changed. Furthermore, the non-viewing period is reflected only onto the image that has a viewing track record, consequently, increase in the preference level for images that are not preferred is avoided.

### Third Embodiment

Next, a third embodiment according to the present invention is explained with reference to FIGS. 19 to 24.

In the third embodiment, explanations about part common to the above embodiments are omitted.

As shown in FIG. 19, standard-or-preference list selecting buttons 309 are displayed on the operation screen 302 in the screen display unit 300 of the display-output unit 70. Via the standard-or-preference list selecting buttons 309, either the standard list or the preference list is selected, so that, in response to selection, the display of shooting-storing dates in the list display section 305 is switched.

FIG. 20 is an operational algorithm for the image display device 100 according to the third embodiment.

As the user selects from the standard-or-preference list selecting buttons 309, the standard list or the preference list is selected (step SF3), accordingly, all of the shooting-storing dates are displayed (step SG3), or only preferred shooting-storing dates are displayed (step SG2), respectively, as shown in FIG. 21.

Similarly to the first embodiment, in FIG. 20, when viewing images by the user is finished (step SF8), the preference level is renewed by reflecting the viewing time in accordance with the algorithm shown in FIG. 10 (step SF11). According to the third embodiment, the preferred shooting-storing dates are renewed by reflecting a user's viewing state after the image display device 100 is booted up (step SF12).

Operations shown in FIG. 20 are explained below in detail.

In FIG. 20, steps SF1 and SF2 are similar to steps S1 and S2 in FIG. 8 respectively; and steps SF4 to SF11 are similar to steps S3 to S10 in FIG. 8 respectively; so that explanations about these are omitted.

At step SF3 in FIG. 20, an algorithm for selecting the shooting-storing date display mode (standard or preference) is executed. The algorithm for selecting the shooting-storing date display mode (standard or preference) is explained with reference to FIG. 21.

As shown at step SG1 in FIG. 21, to begin with, the display-and-operation control unit 60 determines whether the preference list selecting button of the standard-or-preference list selecting buttons 309 is selected. As a result of the determination, if the preference list selecting button is selected (Yes at step SG1), the display-and-operation control unit 60 causes the list display section 305 to display only the shooting-storing dates that are selected (extracted) as preferred shooting-storing dates at step SF12 in the previous flow (step SG2). By contrast, as a result of the determination, if the standard list selecting button is selected (No at step SG1), similarly to the above embodiment, all shooting-storing dates are displayed in ascending order of date-and-time (step SG3).

At step SF12 in FIG. 20, the shooting-storing dates preferred by the user are extracted (renewed) based on an algorithm for extracting preferred shooting-storing date shown in FIG. 22.

According to the algorithm shown in FIG. 22, preferred shooting-storing dates are extracted by using statistics of the viewing time. To begin with, the preference-level calculating unit 40 calculates ⁻(Lₙ) which denotes the average of the preference levels of all images that belong to the same shooting-storing date (here, as shown in FIG. 22, the upper bar denotes an upper bar of the next symbol in ( ), and hereinafter, the same to this); and by using this, further calculates ⁻(Lₐₗₗ), which denotes the average of the preference levels of images on all shooting-storing dates. Moreover, the preference-level calculating unit 40 calculates σLₐₗₗ, which denotes the standard deviation of the preference levels of images on all shooting-storing dates. The display-and-operation control unit 60 then selects a shooting-storing date as the shooting-storing date preferred by the user only if ⁻(Lₙ) is larger than (⁻(Lₐₗₗ)−σLₐₗₗ) (Yes at step SH3) (step SH4).

FIG. 24 depicts the shooting-storing dates that are extracted according to the algorithm shown in FIG. 22, and then displayed as the shooting-storing dates preferred by the user at step SG2 in FIG. 21, and shooting-storing dates that are not displayed as the shooting-storing dates preferred by the user. In addition to the statistics according to the third embodiment, preferred shooting-storing dates can be extracted by using other statistics.

At step SF12 in FIG. 20, the shooting-storing dates preferred by the user can be extracted (renewed) based on an algorithm for extracting preferred shooting-storing date shown in FIG. 23 instead of the algorithm for extracting preferred shooting-storing date shown in FIG. 22.

According to the algorithm shown in FIG. 23, preferred shooting-storing dates are extracted by using a viewing rate of shooting-storing date (number of viewed images/total number of images). Here, the viewing rate is a share of the number of images dated on the same shooting date or storing date (total number of images) held by the number of images that have a viewing track record (number of viewed images).

To begin with, the display-and-operation control unit 60 calculates Rₙ, which denotes the viewing rate with respect to each shooting-storing date, and by using this, further calculates ⁻(Rₐₗₗ), which denotes the viewing rate for all shooting-storing dates. Moreover, the display-and-operation control unit 60 calculates σRₐₗₗ, which denotes the standard deviation of all of the viewing rates per shooting-storing date. The display-and-operation control unit 60 then selects a shooting-storing date as the shooting-storing date preferred by the user only if Rₙ is larger than (⁻(Rₐₗₗ)−σRₐₗₗ) (Yes at step SI3) (step SI4).

The method of displaying thumbnails of preferred images by using the preference level is similar to the method according to the first or second embodiments (steps SF5 and SF11 in FIG. 20).

According to the third embodiment as described above, a selection list of shooting-storing dates (the list display section 305) can display only preferred shooting-storing dates with respect to each user. As a result, shooting-storing dates in which the user is not interested can be excluded from the list, so that the user can view preferred images with a shorter time.

### Fourth Embodiment

Next, a fourth embodiment according to the present invention is explained with reference to FIGS. 25 to 27.

In the fourth embodiment, explanations about part common to the above embodiments are omitted.

FIG. 25 is a general block diagram of an image display device 100a according to the fourth embodiment. According to the fourth embodiment, in addition to displaying images, music is also played simultaneously with displaying image. The music is input by an image-and-music input unit 10a from a compact disk (CD), a magnetic disk (MD), a memory card, or the Internet by downloading.

An image-and-music storing unit 20a stores therein image data and music data input by the image-and-music input unit 10a. Simultaneously with when music is stored in the image-and-music storing unit 20a, a music-information and listening-history database 90 stores therein music information about the music.

FIG. 27 depicts the music-information and listening-history database 90. The music-information and listening-history database 90 includes a music-information database section 91 and a listening-history database section 92.

Simultaneously with when the music is stored in the image-and-music storing unit 20a, the music-information database section 91 in the music-information and listening-history database 90 stores therein information about the music, such as a title of the music, a singer, lyrics, a composer, a lyric writer, and a sales date, which are used when the music is played as background music for an image.

When the user operates the user operation unit 80, and then listens to the music stored in the image-and-music storing unit 20a via a display-play-and-operation control unit 60a, information about a listening history of the music by the user, such as the number of times of listening and the date-and-time of listening, is stored in the listening-history database section 92. The information stored in the listening-history database section 92 is used when the music is played as background music for an image.

In the listening-history database 90, the music-information database section 91 and the listening-history database section 92 are provided for each user. However, the music-information database section 91 can be provided in common use with all users. At step SJ2 shown in FIG. 26, when a listening environment is selected with the user selecting buttons 304, in accordance with the selection, the listening-history database 90 (or, at least the listening-history database section 92) to be referred by the display-play-and-operation control unit 60a is switched.

In FIG. 27, an ID of each piece of music is recorded in an identification (ID) recording area 601 in the music-information database section 91; information about music data name is recorded in a music data-name recording area 602; information about lyrics is recorded in a lyric data-name recording area 603; information about a music title is recorded in a music-title recording area 604; information about a singer is recorded in a singer recording area 605; information about a composer is recorded in a composer recording area 606; information about a lyric writer is recorded in a lyric writer recording area 607; information about a storing date-and-time is recorded in a storing date-and-time recording area 608; and information about a sales date is recorded in a sales date recording area 609.

In FIG. 27, information about the number of times of listening to each piece of music is recorded in a listening number-of-times recording area 610 in the listening-history database section 92; information about the ID of played music that is the same ID as in the ID recording area 601 is recorded in an ID recording area 611; and information about a listening history of the played music is recorded in a listening-history recording area 612.

FIG. 26 is an operational algorithm for the image display device 10a according to the fourth embodiment.

In FIG. 26, steps SJ1 to SJ4 are similar to steps S1 to S4 in FIG. 8 respectively; and steps SJ6 to SF11 are similar to steps S5 to S10 in FIG. 8 respectively; so that explanations about these are omitted.

When the user selects a shooting-storing date (step SJ3), the display-play-and-operation control unit 60a plays the music corresponding to the selected shooting-storing date as background music (step SJ5). Every time when the selection of the shooting-storing date is changed (step SJ3), the display-play-and-operation control unit 60a changes the music to be played as background music (step SJ5). Operations other than the above are similar to those included in the algorithm shown in FIG. 9 according to the first embodiment. Moreover, music corresponding to an image can be played when the image is selected and displayed in an enlarged form (step SJ6). Methods of selecting music to be played include the following conceivable methods:

(1) selecting a piece of music that is played on a date-and-time that is the closest to the selected shooting-storing date;

(2) selecting a piece of music that is played on a date-and-time that is the closest to the latest viewing date-and-time for image(s) dated on the selected shooting-storing date;

(3) selecting a piece of music that is played the most number of times from among music pieces that are played within a certain period before and after the selected shooting-storing date;

(4) selecting at random a piece of music in high ranks in terms of the number of times of listening from among music pieces that are played within a certain period before and after the selected shooting-storing date;

(5) selecting a piece of music about which music information (music attribution data, such as music title, singer, lyrics, composer, lyric writer, and sales date) corresponds to image information about an image dated on the selected shooting-storing date or an image displayed in an enlarged form;

(6) selecting at random a piece of music in top ranks of hit music charts during the same year, the same month, or the same week to the selected shooting-storing date;

(7) selecting at random a piece of music in top ranks of hit music charts during the same year, the same month, or the same week to the latest listening date-and-time for images dated on the selected shooting-storing date; and

(8) selecting at random a piece of music in top ranks of hit music charts during the same year, the same month, or the same week to the latest listening date-and-time for the image with the highest preference level from among images dated on the selected shooting-storing date.

Music can be selected by using any of the methods (1) to (8). These methods can be combined. Moreover, music can be selected by using other methods than the above.

According to the fourth embodiment, when displaying an image, playing music that the user used to listen to at the time when the image was shot or stored, or the user viewed the image, such as favorite music, hit music, or music related to the image, has an effect of reminding the user about a situation of the time when shooting, storing, or viewing the image. This enables the user to view the image with deeper emotion.

### Fifth Embodiment

Next, a fifth embodiment according to the present invention is explained with reference to FIG. 28.

In the fifth embodiment, explanations about part in common with the above embodiments are omitted.

FIG. 28 is a general block diagram of an image display device 100b according to the fifth embodiment.

The image display device 100 according to the first embodiment stores all images in the image storing unit 20 in the image display device 100. By contrast, according to the fifth embodiment, image data input by an image input unit 10b is stored into a storage 25 on the Internet 24 via a communication unit 23, i.e., an online storage. When a user desires to view an image by operating the user operation unit 80, the image is input into the image display device 100b from the storage 25. Consequently, the image display device 100b does not need to include an image storing unit therein.

In addition, in the above case, it can be configured that the image display device 100b includes a minimum image storing unit (shown with the broken line) therein, and the user can stores only preferred images into the image storing unit in the image display device 10b, while storing the rest of images in the online storage. Moreover, it can be configured that images are stored in the online storage when the storage space in the image storing unit in the image display device 100b is insufficient.

According to the fifth embodiment, the image display device 100b does not need to include an storing unit for images by storing images into an external storage. As a result, the device can be simplified, and moreover, a risk of image data loss caused by a failure in the storing unit is avoided. Moreover, the image display device 100b includes only the storing unit with a minimum capacity required, stores only preferred images in the storing unit, and stores the others in the external storage, thereby achieving an efficient storage.

The first to fifth embodiments can be applied to various devices that include a storage device for storing therein images. The image display devices 100, 100a, 100b, each can be applied to mobile devices as a device with a display-output unit (display device), such as, a personal computer, a digital camera, a cellular phone, an information terminal, and an image viewer. The image display control apparatus 200 according to the first to fifth embodiments can be applied to devices without display-output unit, for example, consumer appliances, such as, a home server, a hard disk drive (HDD) recorder, a digital versatile disk (DVD) recorder, and an HDD and DVD recorder, and network devices, such as a server, and an online storage.

According to the embodiments, the following items are disclosed.

(Note 1)

An image display control apparatus that is the image display control apparatus 200 that performs a control to display an image with a high preference level L of a user from among a plurality of images; where the preference level L for the image is obtained based on data on time in a viewing history of the image (viewing time Tv), and then a control is performed to display the image with the high preference level L based on the preference level L for the image.

According to Note 1, because a preference level L for an image is obtained based on data on time in a viewing history of the image by a user, differing from Patent Document 1, if the user selects the image by fault and re-selects another image immediately, the preference level L for the image is not increased. By using the preference level L, the user's preference to the image can be precisely reflected. Moreover, because the degree of preference to each image can be differentiated in accordance with the preference level L, display can be devised, for example, with a control to display images in descending order of degree of preference when conducting display of images.

(Note 2)

An image display control apparatus that is the image display control apparatus 200 that performs a control to display an image with a high preference level L of a user from among a plurality of images; where when a shooting-storing date is specified from among candidates of a plurality of shooting dates or storing dates displayed in the list display section 305, the information screen 301 is controlled to display thumbnails from which an image dated on the specified shooting-storing date is selectable; the preference level L for the image is obtained based on data on time in the viewing history of the image (viewing time Tv); and it is determined whether the shooting-storing date is to be contained in the candidates based on the average of the preference levels of the images dated on the same shooting-storing date ⁻(Lₙ).

(Note 3)

An image display control apparatus that performs a control to display an image with a high preference level L of a user from among a plurality of images; where when a shooting-storing date is specified from among candidates of a plurality of shooting dates or storing dates displayed in the list display section 305, the information screen 301 is controlled to display thumbnails from which an image dated on the specified shooting-storing date is selectable; and it is determined whether the shooting-storing date is to be contained in the candidates based on a share of the number of the images dated on the same shooting-storing date held by the number of the images that have a viewing track record R, based on data indicating the viewing rack records for the images.

According to Notes 2 and item 3, the user can select (view) a preferred image in the short time from among candidates (the list display section 305).

(Note 4)

An image display method for displaying an image with a high preference level L of a user from among a plurality of images, the image display method including a step of obtaining the preference level L for the image based on data on time in a viewing history of the image (viewing time Tv), and a step of displaying the image with the high preference level L preferentially based on the preference level L for the image.

According to Note 4, similarly to the item 1, because a preference level L for an image is obtained based on data on time in a viewing history of the image by a user (viewing time Tv), differing from Patent Document 1, if the user selects the image by fault and re-selects another image immediately, the preference level L for the image is not increased. By using the preference level L, the user's preference to the image can be precisely reflected. Moreover, because the degree of preference to each image can be differentiated in accordance with the preference level L, display can be devised, for example, to display images are in descending order of degree of preference when displaying images.

### INDUSTRIAL APPLICABILITY

As described above, the image display control apparatus according to the present invention is suitable particularly to an image display control apparatus that performs a control to display an image reflected with preference of a user from among a plurality of images.

1-14. (canceled)

15. An image display-control apparatus that performs a control to display an image from among a plurality of images, the image display-control apparatus comprising:
a calculating unit that calculates a preference level of a user for each of the images based on data on time in a viewing history of the image; and
a control unit that performs a display control to display an image with a high preference level from among preference levels calculated by the calculating unit, and performs a play-back control to play music along with display of the image based on data on a date of any one of shooting and storing the image, and data on a period and number of times of listening the music, the music having a large number of times of listening within a certain period that includes the date of any one of shooting and storing the image.

16. The image display control apparatus according to claim 15, wherein the data on time in the viewing history of the image is data on time for which the image is viewed.

17. The image display control apparatus according to claim 16, wherein
the data on time in the viewing history of the image includes data on time for which the image is not viewed in addition to the data on the time for which the image is viewed, and
the preference level for the image includes freshness of the image.

18. The image display control apparatus according to claim 16, wherein the time for which the image is viewed is a time that starts when the image is changed from a thumbnail display state to an enlarged display state, and ends when the image is changed from the enlarged display state to the thumbnail display state.

19. The image display control apparatus according to claim 17, wherein the time for which the image is not viewed is a time, in relation to an image that has a viewing track record, from when the image is viewed last time until when the image display control apparatus is booted up.

20. The image display control apparatus according to claim 15, wherein an upper limit is set for an increase in the preference level for the image by viewing the image per once.

21. The image display control apparatus according to claim 16, wherein the preference level for the image is obtained based on a simple decreasing function that depends on a variable of a time for which the image is viewed and a variable of an elapsed time since the image is viewed for first time.

22. The image display control apparatus according to claim 20, wherein the preference level for the image is obtained based on a simple decreasing function that depends on a variable of a time for which the image is viewed and a variable of an elapsed time since the image is viewed for first time.

23. The image display control apparatus according to claim 15, wherein the control unit performs the play-back control to play music along with the display control to display an image based on data on any one of a shooting date, a storing date and a viewing period of the image, and data on a listening period of the music, the music having a listening period corresponding to any one of the shooting date, the storing date and the viewing period of the image to be displayed.

24. The image display control apparatus according to claim 15, wherein the control unit performs the play-back control to play music along with the display control to display an image based on image attribution data that includes a date of any one of shooting and storing, a shooting location, and a comment in relation to the image, and music attribution data that includes a music title, a singer, lyrics, a composer, a lyric writer and a sales date in relation to the music, the music having the music attribution data corresponding to the image attribution data on the image to be displayed.

25. The image display control apparatus according to claim 15, wherein the control unit performs the play-back control to play music along with the display control to display an image based on data on any one of a shooting date, a storing date and a viewing period of the image, and data on a period in which the music makes a hit, the music having the period in which the music makes a hit corresponding to any one of the shooting date, the storing date and the viewing period of the image to be displayed.

26. An image display-control apparatus that performs a control to display an image with a high preference level of a user from among a plurality of images, the image display-control apparatus comprising:
a control unit that performs a control to display an image dated on specified date of any one of shooting and storing in a selectable manner, when the date of any one of shooting and storing is specified from among displayed candidates of a plurality of dates of any one of shooting and storing; and
a calculating unit that calculates a preference level of a user for each of the images based on data on time in a viewing history of the image, wherein the control unit determines whether the specified date of any one of shooting and storing is to be contained in the candidates based on an average of preference levels calculated by the calculating unit for the images dated on a same shooting-storing date.

27. An image display-control apparatus that performs a control to display an image with a high preference level of a user from among a plurality of images, the image display-control apparatus comprising:
a control unit that performs a control to display an image dated on specified date of any one of shooting and storing in a selectable manner, when the date of any one of shooting and storing is specified from among displayed candidates of a plurality of dates of any one of shooting and storing, wherein the control unit determines whether the specified date of any one of shooting and storing is to be contained in the candidates based on a share of number of images dated on a same date of any one of shooting and storing held by number of images each of which has a viewing track record based on data indicating viewing rack records for the images.

28. A method for displaying an image with a high preference level of a user from among a plurality of images, the method comprising:
obtaining a preference level of a user for each of the images based on data on time in a viewing history of the images;
displaying an image with high preference level preferentially based on the preference level for the images obtained at the obtaining; and
playing music along with display of the image at the displaying based on data on a date of any one of shooting and storing the image, and data on a listening period and number of times of listening of the music, the music having a large number of times of listening within a certain period that the date of any one of shooting and storing the image to be displayed.
